(19) United States
(12) Patent Application Publication
(10) Pub. No.: US 2025/0220642 A1
(43) Pub. Date: Jul. 3, 2025

(54) SCHEDULING COLLISION RESOLUTION FOR SIDELINK AND UU COMMUNICATIONS

(71) Applicant: QUALCOMM Incorporated, San Diego, CA (US)

(72) Inventors: Siyi CHEN, Beijing (CN); Jing SUN, San Diego, CA (US); Chih-Hao LIU, San Diego, CA (US); Xiaoxia ZHANG, San Diego, CA (US); Changlong XU, Beijing (CN); Luanxia YANG, Beijing (CN); Shaozhen GUO, Beijing (CN); Hao XU, Beijing (CN)

(21) Appl. No.: 18/847,398

(22) PCT Filed: May 10, 2022
(86) PCT No.: PCT/CN2022/091900

§ 371 Date: Sep. 16, 2024

(51) Int. Cl. H04W 72/0446; H04W 72/115; H04W 72/25

(52) U.S. Cl. CPC H04W 72/0446; H04W 72/115; H04W 72/25

(57) ABSTRACT

A method of wireless communication performed at a user equipment (UE) includes: receiving a first time domain configuration for a Uu component carrier (CC); receiving a second time domain configuration for a sidelink (SL) resource pool, wherein the Uu CC and the SL resource pool are within a same frequency band; and communicating, based on the first time domain configuration, the second time domain configuration, and an intra-band priority configuration, a first communication at a first time period, wherein a second communication is scheduled for at least a portion of the first time period, wherein one of the first communication or the second communication comprises an SL communication in a first link direction, and wherein the other of the first communication or the second communication comprises a Uu communication for a second link direction opposite the first link direction.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long-term evolution (LTE) technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

In a wireless communication network, a BS may communicate with a UE using a Uu interface in which the UE communicates with a network via the BS in an uplink (UL) direction and a downlink (DL) direction. UEs may also communicate with one another using a sidelink (SL) interface, which may also be referred to as a PC5 interface. The sidelink interface or architecture allows a UE to send data to another UE (e.g., from one vehicle to another vehicle) without tunneling through the BS and/or an associated core network. In some aspects, a UE may be provided with a first set of resources for communication with a network over a Uu interface, and a second set of resources for communication with other UEs over a SL interface

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

A user equipment (UE) may be configured by a network (e.g., via a network entity or network device) to communicate over a Uu interface in one or more component carriers (CCs). Further, the UE may be configured with one or more sidelink resource pools for communicating with other UEs over a sidelink interface. In some aspects, the CCs for Uu communication may be in a same frequency band as the resource pools for SL communication. A UE may be subject to certain operating constraints. For example, a UE may not be configured to transmit and receive at a same time using intra-band frequency resources. However, in some instances, a UE may be indicated to communicate a Uu communication in a first link direction (e.g., transmit), and communicate a SL communication in a second link direction (e.g., receive). The UE may not be allowed to simultaneously transmit and receive at the same time in the intra-band frequency resources.

The present disclosure provides schemes, mechanisms, and systems for resolving collisions between Uu and SL communications on intra-band frequency resources. For example, a UE may be configured with an intra-band priority configuration for determining relative intra-band priorities between a Uu communication colliding in time with an SL communication having a different link direction than the Uu communication. The UE may be configured with a first time domain configuration for a Uu component carrier (CC), and a second time domain configuration for a sidelink (SL) resource pool in a same frequency band as the Uu CC. The UE may be indicated or otherwise configured to transmit a first communication on the Uu CC and a second communication on the SL resource pool in different link directions and in an overlapping time period. The UE may resolve the scheduling collision based on the intra-band priority configuration and communicate the first communication in the first time period.

According to one aspect of the present disclosure, a method of wireless communication performed at a user equipment (UE) includes: receiving a first time domain configuration for a Uu component carrier (CC); receiving a second time domain configuration for a sidelink (SL) resource pool, wherein the Uu CC and the SL resource pool are within a same frequency band; and communicating, based on the first time domain configuration, the second time domain configuration, and an intra-band priority configuration, a first communication at a first time period, wherein a second communication is scheduled for at least a portion of the first time period, wherein one of the first communication or the second communication comprises an SL communication in a first link direction, and wherein the other of the first communication or the second communication comprises a Uu communication for a second link direction opposite the first link direction.

According to another aspect of the present disclosure, a user equipment (UE) comprises: a processor; and a transceiver, wherein the UE is configured to: receive a first time domain configuration for a Uu component carrier (CC); receive a second time domain configuration for a sidelink (SL) resource pool, wherein the Uu CC and the SL resource pool are within a same frequency band; and communicate, based on the first time domain configuration, the second time domain configuration, and an intra-band priority configuration, a first communication at a first time period, wherein a second communication is scheduled for at least a portion of the first time period, wherein one of the first communication or the second communication comprises an SL communication in a first link direction, and wherein the other of the first communication or the second communication comprises a Uu communication for a second link direction opposite the first link direction.

According to another aspect of the present disclosure, a non-transitory, computerreadable medium having program code recorded thereon, wherein the program code comprises instructions executable by a processor of a user equipment (UE) to cause the UE to: receive a first time domain configuration for a Uu component carrier (CC); receive a second time domain configuration for a sidelink (SL) resource pool, wherein the Uu CC and the SL resource pool are within a same frequency band; and communicate, based on the first time domain configuration, the second time domain configuration, and an intra-band priority configuration, a first communication at a first time period, wherein a second communication is scheduled for at least a portion of the first time period, wherein one of the first communication or the second communication comprises an SL communication in a first link direction, and wherein the other of the first communication or the second communication comprises a Uu communication for a second link direction opposite the first link direction.

According to another aspect of the present disclosure, user equipment (UE), comprising: means for receiving a first time domain configuration for a Uu component carrier (CC); means for receiving a second time domain configuration for a sidelink (SL) resource pool, wherein the Uu CC and the SL resource pool are within a same frequency band; and means for communicating, based on the first time domain configuration, the second time domain configuration, and an intra-band priority configuration, a first communication at a first time period, wherein a second communication is scheduled for at least a portion of the first time period, wherein one of the first communication or the second communication comprises an SL communication in a first link direction, and wherein the other of the first communication or the second communication comprises a Uu communication for a second link direction opposite the first link direction. Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 is a diagram illustrating an example disaggregated BS architecture according to some aspects of the present disclosure.

FIG. 3 illustrates a sidelink communication network according to some aspects of the present disclosure.

FIG. 4 illustrates sidelink resources associated with a wireless communication network according to some aspects of the present disclosure.

FIG. 5 illustrates a radio frame structure according to some aspects of the present disclosure.

FIG. 6A illustrates a sidelink and downlink collision scenario according to some aspects of the present disclosure.

FIG. 6B illustrates a sidelink and uplink collision scenario according to some aspects of the present disclosure.

FIG. 7 is a signaling diagram of a communication method according to some aspects of the present disclosure.

FIG. 8 illustrates an intra-band collision resolution scheme according to some aspects of the present disclosure.

FIG. 9 illustrates an intra-band collision resolution scheme according to some aspects of the present disclosure.

FIG. 10 illustrates an intra-band collision resolution scheme according to some aspects of the present disclosure.

FIG. 11 illustrates an intra-band collision resolution scheme according to some aspects of the present disclosure.

FIG. 12 is a block diagram of an exemplary user equipment (UE) according to some aspects of the present disclosure.

FIG. 13 is a block diagram of an exemplary base station (BS) according to some aspects of the present disclosure.

FIG. 14 is a flow diagram of a communication method according to some aspects of the present disclosure.

FIG. 15 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (EUTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

A UE may be configured by a network (e.g., via a network entity or network device) to communicate over a Uu interface in one or more frequency carriers. The one or more frequency carriers may be referred to as component carriers in some aspects. The component carriers may be in licensed frequency bands, or in unlicensed frequency bands. Further, the UE may be configured with one or more sidelink resource pools for communicating with other UEs over a sidelink interface. In some aspects, the resources for Uu communication may be in a same frequency band as the resource pools for SL communication. In some aspects, the sidelink resource pools may include one or more sub channels, and one or more slots. Some slots may not be available for sidelink communication, as the slots may be allocated or configured for other purposes. Some sidelink slots may be configured for feedback resources, such as physical sidelink feedback channels (PSFCH). In some aspects, the resource pools may be configured by the network. In other aspects, the resource pools may be configured by one or more other UEs communicating over the sidelink interface. In other aspects, the sidelink resource pools may be preconfigured or preloaded on a UE.

The UE may also be configured with one or more time domain configurations. For example, a UE may be configured for Uu time division duplexing (TDD) in which one subset of resources is allocated for downlink reception, and the second subset of resources is allocated for uplink transmission. The time domain configuration may also include one or more flexible resources. The flexible resources may include a combination of downlink and uplink resources, such as downlink and/or uplink symbols. In other aspects, the time domain configuration may include or indicate one or more flexible resources for gaps between different link directions. Further, the UE may be configured with a sidelink time domain configuration. In some aspects, the sidelink time domain configuration may include a sidelink bitmap, a sidelink dynamic grant, or any other suitable provision of sidelink time domain resources. In some aspects, the resources available for cyclic communications may be based on a combination of a Uu time domain configuration and the sidelink time domain configuration. For example, in some aspects, sidelink communications may be confined within the Uu time domain resources allocated for uplink. In another aspect, cyclic communications may be confined within the time domain resources allocated for downlink reception.

A UE may be subject to certain operating constraints. For example, a UE may not be configured to transmit and receive at a same time using intra-band frequency resources. In this regard, the UE may be configured with a first set of Uu link frequency resources and a second set of sidelink frequency resources based on a sidelink resource pool configuration. As explained above, the sidelink frequency resources may be intra-band with the Uu link frequency resources. In some instances, a UE may be indicated to transmit a UL communication over the Uu link, and to receive a SL communication over the SL link at a same time. For example, the UE may receive downlink control information (DCI) including a grant for a DL reception during a first time period, and may also receive SCI or DCI indicating a grant for SL transmission during the same first time period. The UE may not be allowed to simultaneously transmit and receive at the same time in the intra-band frequency resources. Accordingly, the UE may need to resolve the collision.

The present disclosure provides various schemes, mechanisms, and devices for resolving collisions between Uu and SL communications on intra-band frequency resources. For example, a UE may be configured with an intra-band priority configuration for determining relative intra-band priorities between a Uu communication colliding with an SL communication having a different link direction than the Uu communication. In some aspects, the intra-band priority configuration may include or indicate rules for prioritizing one of the communications over one or more other communications to resolve the collision. The rules of the intra-band priority configuration may be based on whether the scheduled sidelink communication is based on the dynamic sidelink grant, whether a DCI has been received validating a resource for sidelink communication or for Uu communication, a listen-before-talk (LBT) success report, and/or a traffic type of the colliding communications. In some aspects, the UE may determine or select one of the colliding communications for communication (reception or transmission) based on the Uu time domain configuration, the SL time domain configuration, and the intra-band priority configuration. Accordingly, the UE and/or the network may be configured with one or more mechanisms for prioritizing either Uu or SL communications having different link directions.

Aspects of the present disclosure may provide several benefits. For example, the collision resolution mechanisms described herein may provide for efficient collision resolution schemes that prioritize either Uu or SL communications in intra-band frequency resources based on one or more relevant channel conditions or parameters of the scheduled communications. For example, communications having a higher traffic priority may be prioritized over communications having a lower traffic priority to improve and/or maintain network performance and user experience.

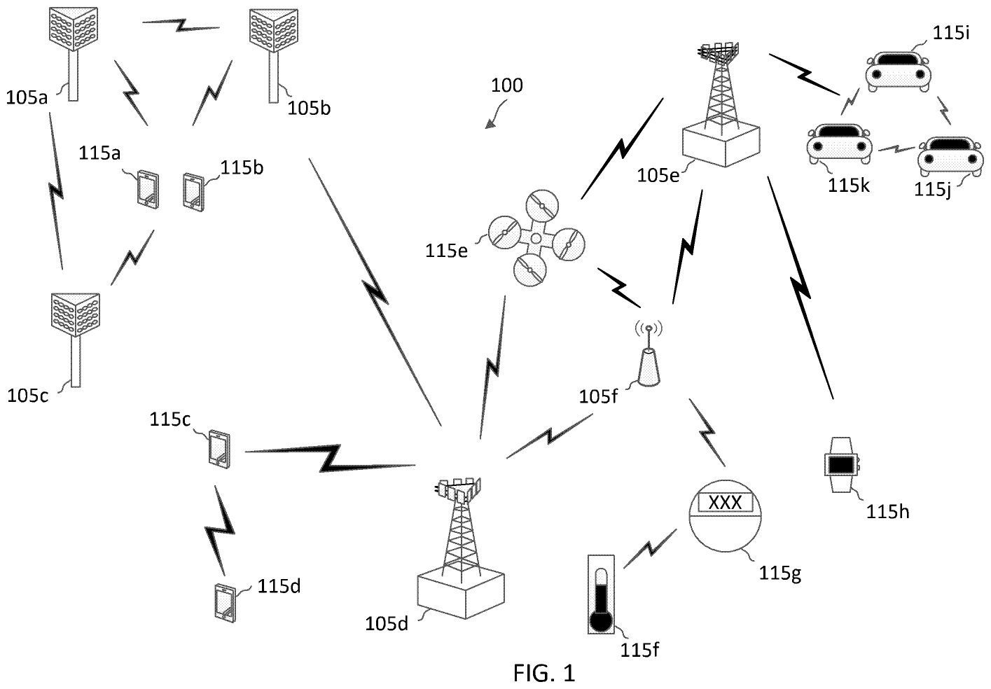

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (COMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

In some aspects, the UEs 115c and UE 115d may be sidelink UEs. The UE 115c may receive an indicator indicating a set of start times associated with a transmission opportunity from the BS 105. The UE 115c may receive the indicator indicating the set of start times associated with the TXOP from the BS 105 in a physical downlink control channel (PDCCH), a physical broadcast channel (PBCH), a physical downlink shared channel (PDSCH), or other suitable channel. In some aspects, the UE 115c may receive the indicator in downlink control information (e.g., a DCI3_x or other DCI communication format). The UEs 115c and 115d may operate in a licensed and/or unlicensed frequency band.

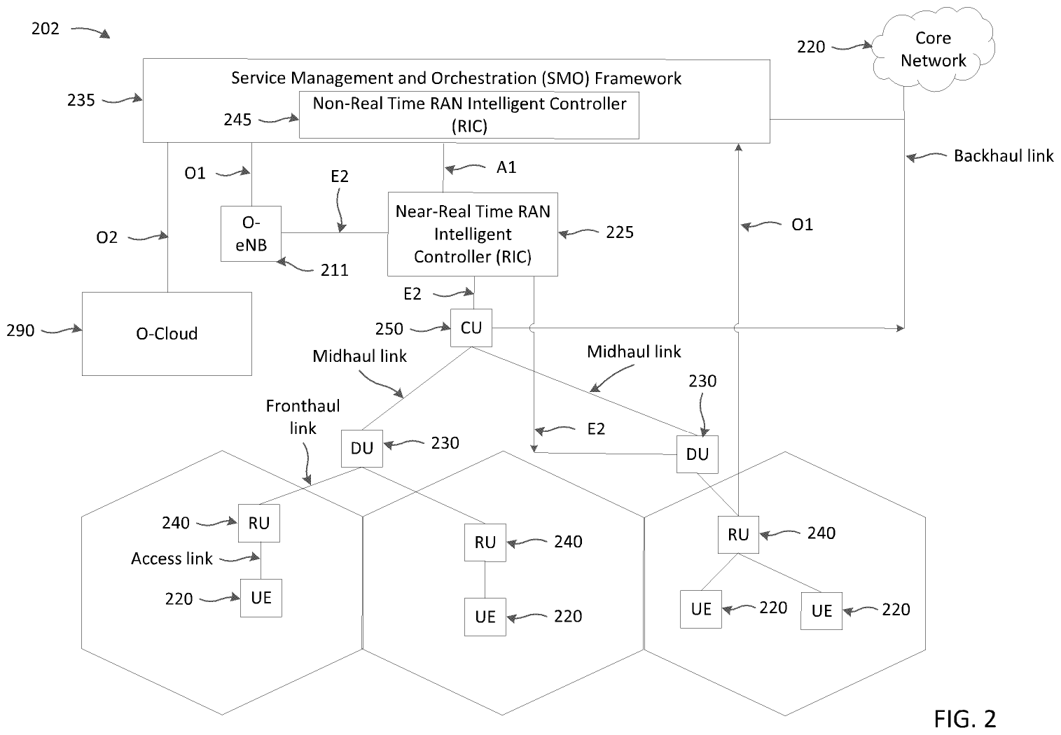

FIG. 2 shows a diagram illustrating an example disaggregated base station 202 architecture. The disaggregated base station 202 architecture may include one or more central units (CUs) 250 that can communicate directly with a core network via a backhaul link, or indirectly with the core network 100 through one or more disaggregated base station units (such as a Near-Real Time (Near-RT) RAN Intelligent Controller (RIC) 225 via an E2 link, or a Non-Real Time (Non-RT) RIC 245 associated with a Service Management and Orchestration (SMO) Framework 235, or both). A CU 250 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 220 via one or more radio frequency (RF) access links. In some implementations, the UE 220 may be simultaneously served by multiple RUs 240.

Each of the units, i.e., the CUS 250, the DUs 230, the RUs 240, as well as the Near-RT RICs 225, the Non-RT RICs 245 and the SMO Framework 235, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 250 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 250. The CU 250 may be configured to handle user plane functionality (i.e., Central Unit—User Plane (CU-UP)), control plane functionality (i.e., Central Unit—Control Plane (CU-CP)), or a combination thereof. In some implementations, the CU 250 can be logically split into one or more CU-UP units and one or more CU-CP units. The CU-UP unit can communicate bidirectionally with the CU-CP unit via an interface, such as the E1 interface when implemented in an O-RAN configuration. The CU 250 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 250.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 220. In some implementations, real-time and non-real-time aspects of control and user plane communication with the RU(s) 240 can be controlled by the corresponding DU 230. In some scenarios, this configuration can enable the DU(s) 230 and the CU 250 to be implemented in a cloud-based RAN architecture, such as a vRAN architecture.

The SMO Framework 235 may be configured to support RAN deployment and provisioning of non-virtualized and virtualized network elements. For non-virtualized network elements, the SMO Framework 235 may be configured to support the deployment of dedicated physical resources for RAN coverage requirements which may be managed via an operations and maintenance interface (such as an O1 interface). For virtualized network elements, the SMO Framework 235 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 250, DUs 230, RUs 240 and Near-RT RICs 225. In some implementations, the SMO Framework 235 can communicate with a hardware aspect of a 4G RAN, such as an open eNB (O-eNB) 211, via an O1 interface. Additionally, in some implementations, the SMO Framework 235 can communicate directly with one or more RUs 240 via an O1 interface. The SMO Framework 235 also may include a Non-RT RIC 245 configured to support functionality of the SMO Framework 235

The Non-RT RIC 245 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 245 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 250, one or more DUs 230, or both, as well as an O-eNB, with the Near-RT RIC 225.

In some implementations, to generate AI/ML models to be deployed in the Near-RT RIC 225, the Non-RT RIC 245 may receive parameters or external enrichment information from external servers. Such information may be utilized by the Near-RT RIC 225 and may be received at the SMO Framework 235 or the Non-RT RIC 245 from non-network data sources or from network functions. In some examples, the Non-RT RIC 245 or the Near-RT RIC 225 may be configured to tune RAN behavior or performance. For example, the Non-RT RIC 245 may monitor long-term trends and patterns for performance and employ AI/ML models to perform corrective actions through the SMO Framework 235 (such as reconfiguration via O1) or via creation of RAN management policies (such as A1 policies).

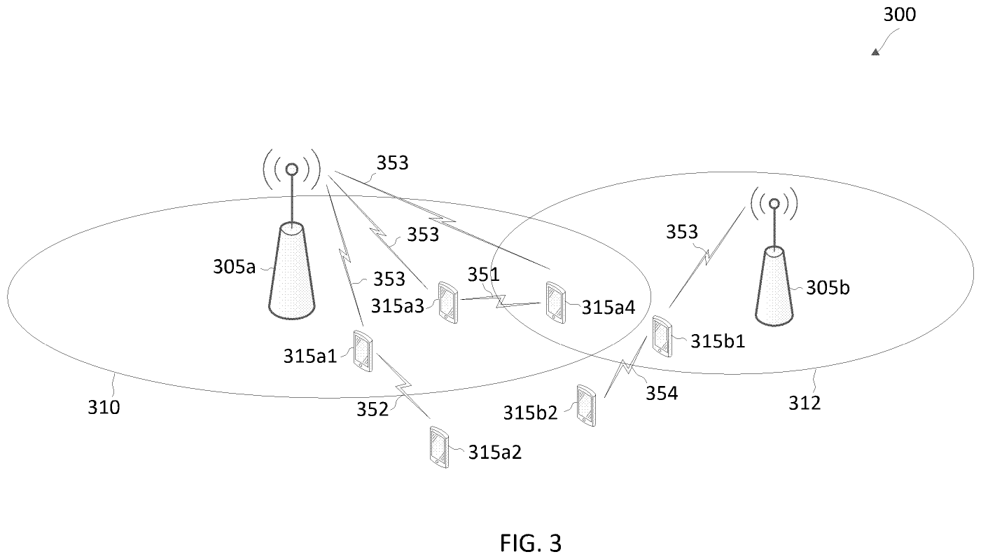

FIG. 3 illustrates an example of a wireless communication network 300 that provisions for sidelink communications according to aspects of the present disclosure. The network 300 may correspond to a portion of the network 100. FIG. 3 illustrates two BSs 305 (shown as 305a and 305b) and six UEs 315 (shown as 315a1, 315a2, 315a3, 315a4, 315b1, and 315b2) for purposes of simplicity of discussion, though it will be recognized that aspects of the present disclosure may scale to any suitable number of UEs 315 (e.g., the about 2, 3, 4, 5, 7 or more) and/or BSs 305 (e.g., the about 1, 2 or more). The BS 305 and the UEs 315 may be similar to the BSs 105 and the UEs 115, respectively. The BSs 305 and the UEs 315 may share the same radio frequency band for communications. In some instances, the radio frequency band may be a 2.4 GHz unlicensed band, a 5 GHz unlicensed band, or a 6 GHz unlicensed band. In general, the shared radio frequency band may be at any suitable frequency.

The BS 305a and the UEs 315a1-315a4 may be operated by a first network operating entity. The BS 305b and the UEs 315b1-315b2 may be operated by a second network operating entity. In some aspects, the first network operating entity may utilize a same radio access technology (RAT) as the second network operating entity. For instance, the BS 305a and the UEs 315a1-315a4 of the first network operating entity and the BS 305b and the UEs 315b1-315b2 of the second network operating entity are NR-unlicensed (NR-U) devices. In some other aspects, the first network operating entity may utilize a different RAT than the second network operating entity. For instance, the BS 305a and the UEs 315a1-315a4 of the first network operating entity may utilize NR-U technology while the BS 305b and the UEs 315b1-315b2 of the second network operating entity may utilize WiFi or LAA technology.

In the network 300, some of the UEs 315a1-315a4 may communicate with each other in peer-to-peer communications. For example, the UE 315a1 may communicate with the UE 315a2 over a sidelink 352, the UE 315a3 may communicate with the UE 315a4 over another sidelink 351, and the UE 315b1 may communicate with the UE 315b2 over yet another sidelink 354. The sidelinks 351, 352, and 354 are unicast bidirectional links. Some of the UEs 315 may also communicate with the BS 305a or the BS 305b in a UL direction and/or a DL direction via communication links 353. For instance, the UE 315a1, 315a3, and 315a4 are within a coverage area 310 of the BS 305a, and thus may be in communication with the BS 305a. The UE 315a2 is outside the coverage area 310, and thus may not be in direct communication with the BS 305a. In some instances, the UE 315a1 may operate as a relay for the UE 315a2 to reach the BS 305a. Similarly, the UE 315b1 is within a coverage area 312 of the BS 305b, and thus may be in communication with the BS 305b and may operate as a relay for the UE 315b2 to reach the BS 305b. In some aspects, some of the UEs 315 are associated with vehicles (e.g., similar to the UEs 115i-k) and the communications over the sidelinks 351, 352, and 354 may be C-V2X communications. C-V2X communications may refer to communications between vehicles and any other wireless communication devices in a cellular network.

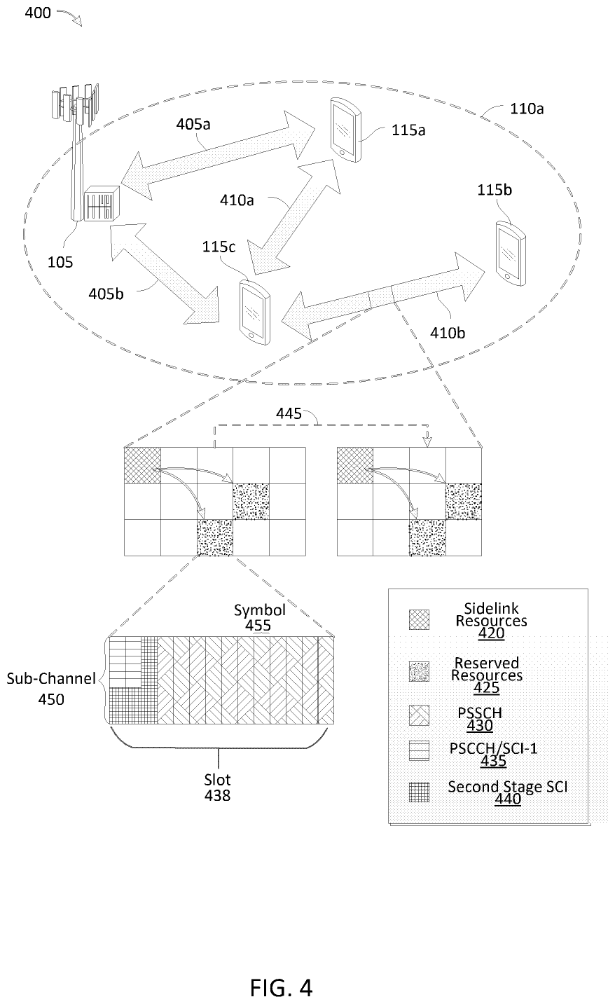

FIG. 4 illustrates sidelink resources associated with a wireless communication network 400 according to some aspects of the present disclosure. The wireless communications network 400 may include a base station 105a and UEs 115a, 115b, and 115c, which may be examples of a BS 105 and a UE 115 as described with reference to FIG. 1. Base station 105a and UEs 115a and 115c may communicate within geographic coverage area 110a and via communication links 405a and 405b, respectively. UE 115c may communicate with UEs 115a and 115b via sidelink communication links 410a and 410b, respectively. In some examples, UE 115c may transmit sidelink control information (SCI) to UEs 115a and 115b via the sidelink control resources 420. The SCI may include an indication of resources reserved for retransmissions by UE 115c (e.g., the reserved resources 425). In some examples, UEs 115a and 115b may determine to reuse one or more of the reserved resources 425.

In some aspects, a device in the wireless communication network 400 (e.g., a UE 115, a base station (BS) 105, or some other node) may convey SCI to another device (e.g., another UE 115, a BS 105, sidelink device or vehicle-to-everything (V2X) device, or other node). The SCI may be conveyed in one or more stages. The first stage SCI may be carried on the PSCCH 435 while the second stage SCI may be carried on the corresponding PSSCH 430. For example, UE 115c may transmit a PSCCH/first stage SCI 435 (e.g., SCI-1) to each sidelink UE 115 in the network (e.g., UEs 115a and 115b) via the sidelink communication links 410. The PSCCH/first stage SCI-1 435 may indicate resources that are reserved by UE 115c for retransmissions (e.g., the SCI-1 may indicate the reserved resources 425 for retransmissions). Each sidelink UE 115 may decode the first stage SCI-1 to determine where the reserved resources 425 are located (e.g., to refrain from using resources that are reserved for another sidelink transmission and/or to reduce resource collision within the wireless communications network 400). Sidelink communication may include a mode 1 operation in which the UEs 115 are in a coverage area of BS 105a. In mode 1, the UEs 115 may receive a configured grant from the BS 105a that defines parameters for the UEs 115 to access the channel. Sidelink communication may also include a mode 2 operation in which the UEs 115 operate autonomously from the BS 105a and perform sensing of the channel to gain access to the channel. In some aspects, during mode 2 sidelink operations, the sidelink UEs 115 may perform channel sensing to locate resources reserved by other sidelink transmissions. The first stage SCI-1 may reduce the need for sensing each channel. For example, the first stage SCI-1 may include an explicit indication such that the UEs 115 may refrain from blindly decoding each channel. The first stage SCI-1 may be transmitted via the sidelink control resources 420. The sidelink control resources 420 may be configured resources (e.g., time resources or frequency resources) transmitted via a PSCCH 435. In some examples, the PSCCH 435 may be configured to occupy a number of physical resource blocks (PRBs) within a selected frequency. The frequency may include a single subchannel 450 (e.g., 10, 12, 15, 30, 35, or some other number of RBs within the subchannel 450). The time duration of the PSCCH 435 may be configured by the BS 105a (e.g., the PSCCH 435 may span 1, 2, 3, or some other number of symbols 455).

The first stage SCI-1 may include one or more fields to indicate a location of the reserved resources 425. For example, the first stage SCI-1 may include, without limitation, one or more fields to convey a frequency domain resource allocation (FDRA), a time domain resource allocation (TDRA), a resource reservation period 445 (e.g., a period for repeating the SCI transmission and the corresponding reserved resources 425), a modulation and coding scheme (MCS) for a second stage SCI-2 440, a beta offset value for the second stage SCI-2 440, a demodulation reference signal (DMRS) port (e.g., one bit indicating a number of data layers), a physical sidelink feedback channel (PSFCH) overhead indicator, a priority, one or more additional reserved bits, or a combination thereof. The beta offset may indicate the coding rate for transmitting the second stage SCI-2 440. The beta offset may indicate an offset to the MCS index. The MCS may be indicated by an index ranging from 0 to 31. For example, if the MCS is set at index 16 indicating a modulation order of 4 and a coding rate of 378, the beta offset may indicate a value of 3 thereby setting the coding rate to 490 based on an MCS index of 18. In some examples, the FDRA may be a number of bits in the first stage SCI-1 that may indicate a number of slots 438 and a number of subchannels reserved for the reserved resources 425 (e.g., a receiving UE 115 may determine a location of the reserved resources 425 based on the FDRA by using the subchannel 450 including the PSCCH 435 and first stage SCI-1 as a reference). The TDRA may be a number of bits in the first stage SCI-1 (e.g., 5 bits, 9 bits, or some other number of bits) that may indicate a number of time resources reserved for the reserved resources 425. In this regard, the first stage SCI-1 may indicate the reserved resources 425 to the one or more sidelink UEs 115 in the wireless communication network 400.

In some aspects, the UEs 115a and UE 115c may be sidelink UEs. The UE 115a may receive an indicator indicating a set of start times associated with a transmission opportunity (TXOP) from the BS 105. The UE 115a may receive the indicator indicating the set of start times associated with the TXOP from the BS 105 in a physical downlink control channel (PDCCH), a physical broadcast channel (PBCH), a physical downlink shared channel (PDSCH), or other suitable channel. In some aspects, the UE 115a may receive the indicator in downlink control information (e.g., a DCI3_x or other DCI communication format). The UEs 115a and 115c may operate in a licensed and/or unlicensed frequency band. The set of start times may indicate a time when the UE 115a may begin to transmit a communication (e.g., a transport block (TB)) to the UE 115c after the UE 115a performs a listen-before-talk (LBT) procedure that passes. In this manner, the BS may increase the spatial diversity of the network in a shared frequency band and increase the overall performance of the network through the use of start times.

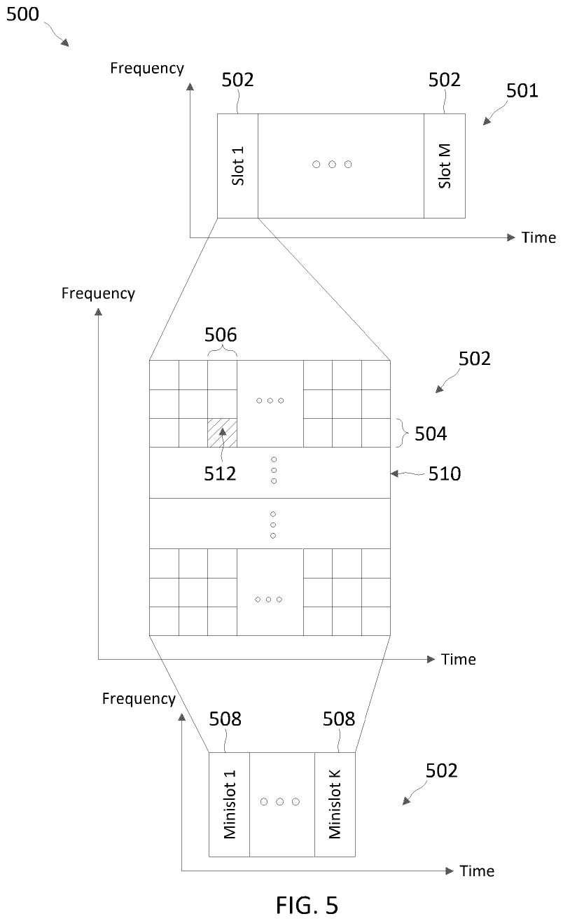

FIG. 5 is a timing diagram illustrating a radio frame structure 500 according to some aspects of the present disclosure. The radio frame structure 500 may be employed by BSs such as the BSs 105 and UEs such as the UEs 115 in a network such as the network 100 for communications. In particular, the BS may communicate with the UE using time-frequency resources configured as shown in the radio frame structure 500. In FIG. 5, the x-axes represent time in some arbitrary units and the y-axes represent frequency in some arbitrary units. The transmission frame structure 500 includes a radio frame 501. The duration of the radio frame 501 may vary depending on the aspects. In an example, the radio frame 501 may have a duration of about ten milliseconds. The radio frame 501 includes M number of slots 502, where M may be any suitable positive integer. In an example, M may be about 10.

Each slot 502 includes a number of subcarriers 504 in frequency and a number of symbols 506 in time. The number of subcarriers 504 and/or the number of symbols 506 in a slot 502 may vary depending on the aspects, for example, based on the channel bandwidth, the subcarrier spacing (SCS), and/or the CP mode. One subcarrier 504 in frequency and one symbol 506 in time forms one resource element (RE) 512 for transmission. A resource block (RB) 510 is formed from a number of consecutive subcarriers 504 in frequency and a number of consecutive symbols 506 in time.

In an example, a BS (e.g., BS 105 in FIG. 1) may schedule a UE (e.g., UE 115 in FIG. 1) for UL and/or DL communications at a time-granularity of slots 502 or TTIs 508. Each slot 502 may be time-partitioned into K number of TTIs 508. Each TTI 508 may include one or more symbols 506. The TTIs 508 in a slot 502 may have variable lengths. For example, when a slot 502 includes N number of symbols 506, a TTI 508 may have a length between one symbol 506 and (N−1) symbols 506. In some aspects, a TTI 508 may have a length of about two symbols 506, about four symbols 506, or about seven symbols 506. In some examples, the BS may schedule UE at a frequency-granularity of a resource block (RB) 510 (e.g., including about 12 subcarriers 504).

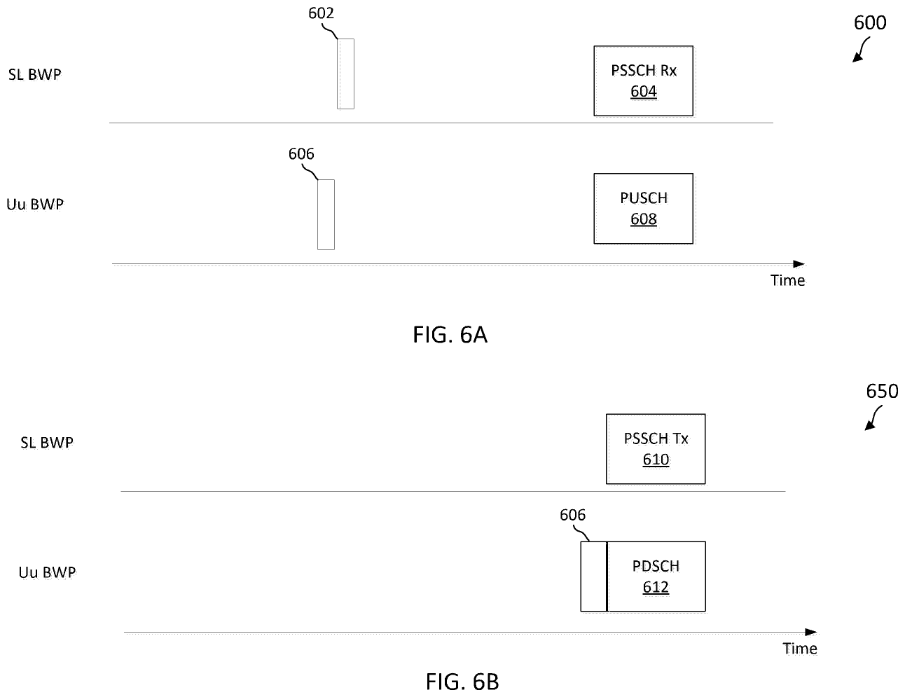

FIGS. 6A and 6B illustrate intra-band SL and Uu collision scenarios 600, 650, according to aspects of the present disclosure. FIG. 6A illustrates a first collision scenario 600 involving a scheduled PSSCH reception 604 and a scheduled PUSCH transmission 608. In the scenario 600, the UE receives a SCI 602 indicating a grant of SL resources for a PSSCH reception 604. The UE also receives a DCI 606 indicating a grant of UL resources for a PUSCH transmission 608. The PSSCH reception 604 and the PUSCH transmission 608 at least partially overlap in time. Further, the SL resource pool associated with the PSSCH 604 may be in a same frequency band as the frequency resources (e.g., CC) associated with the PUSCH transmission 608. Accordingly, the PSSCH reception 604 and the PUSCH transmission may be scheduled for time periods that at least partially overlap and on frequency resources that are within a same frequency band.

FIG. 6B illustrates a second collision scenario 650 involving a scheduled PSSCH transmission 610 and a PDSCH reception 612. Similar to the scenario 600, the scheduled PSSCH transmission 610 and the PDSCH reception 612 may be scheduled on intra-band frequency resources for time periods that at least partially overlap. In the scenario 650, the UE receives, on the Uu BWP, a DCI scheduling the PDSCH reception 612. As explained above, in some aspects, a UE may not be configured to receive and transmit communications on intra-band frequency carriers simultaneously. The scheduling collision between the SL communications and Uu communications described above may be resolved to avoid or prevent simultaneous intra-band reception and transmission. The present disclosure describes methods, schemes, and mechanisms for resolving scheduling collisions between intra-band SL communications and Uu communications having different link directions (e.g., receive and transmit). Aspects of the present disclosure may be performed by one or more UEs and/or one or more network entities or devices. For example, aspects of the present disclosure may be performed by a BS, and/or a CU or DU of a disaggregated BS.

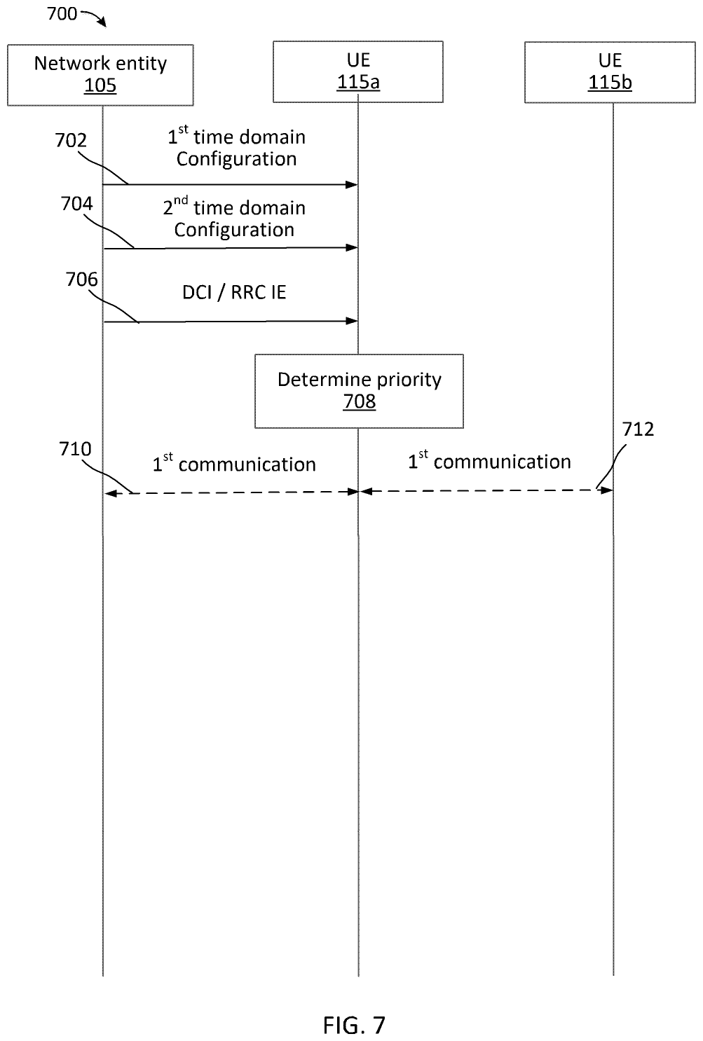

FIG. 7 is a signaling diagram of a communication method according to some aspects of the present disclosure. The method 700 is performed by a network entity 105, a first UE 115a, and a second UE 115b. In some aspects, the network entity 105 may be a base station, or a portion of a disaggregated base station. In some aspects, the network entity 105 may include or represent a plurality of network devices or entities for example, the network entity 105 may include or represent a centralized unit (CU), a distributed unit (DU), and/or any other suitable network device or entity.

At action 702, the network entity 105 transmits, and the first UE 115a receives, a first time domain configuration for a Uu component carrier (CC). In some aspects, the first time domain configuration includes a first time division duplexing (TDD) configuration for the Uu carrier. In other aspects, the first time domain configuration may include or indicate subsets of resources of a TDD previously received at the first UE 115a. For example, the first time domain configuration may indicate one or more downlink (DL) slots, one or more uplink (UL) slots, and/or one or more flexible (F) slots. In some aspects, the first time domain configuration may indicate one or more DL symbols of a slot, one or more UL symbols of a slot, and/or one or more flexible symbols of a slot.

The first time domain configuration may be static, semi-static, and/or dynamic. For example, in some aspects, receiving the first time domain configuration may include receiving a radio resource control (RRC) information element (IE) indicating one or more slot and/or symbol patterns for one or more slots. RRC IE may include a TDD pattern index associated with a pattern of DL, UL, and or F slots. In some aspects, the first time domain configuration may be a cell-level configuration common to a plurality of UEs operating in the cell. In another example, the first time domain configuration may be a dedicated configuration specific to the UE. In another aspect, receiving the first time domain configuration may include receiving downlink control information (DCI) dynamically indicating the TDD. In some aspects, the DCI may include DCI format 2_0. The DCI format 2_0 may include one or more slot format indicators (SFIs) for a group of UEs, or for individual UEs, such as the UE of the method 1400.

At action 704, the network entity 105 transmits, and the first UE 115a receives, a second time domain configuration for a sidelink (SL) resource pool. In some aspects, the second time domain configuration includes a second time division duplexing (TDD) configuration for the SL resource pool. The second time domain configuration may include a bitmap, a SL grant, and/or a semi-static configuration. The second time domain configuration may be carried by or indicated in a RRC IE, DCI, and/or any other suitable communication.

In some aspects, the Uu CC and the SL resource pool are within a same frequency band. In some aspects, the SL resource pool may be referred to as a SL CC, a SL carrier, and/or a SL bandwidth part (BWP). In some aspects, the Uu CC and the SL resource pool may be described as intra-band. However, it will be understood that the Uu CC and the SL resource pool may not overlap in frequency in some aspects. In other aspects, the Uu CC and the SL resource pool may at least partially overlap in frequency. In some aspects, the SL resource pool may include a set of unlicensed frequency resources. In some aspects, the Uu CC may include one or more licensed component carriers or frequency bands. In other aspects, both the SL resource pool and the Uu CC are in an unlicensed frequency band.

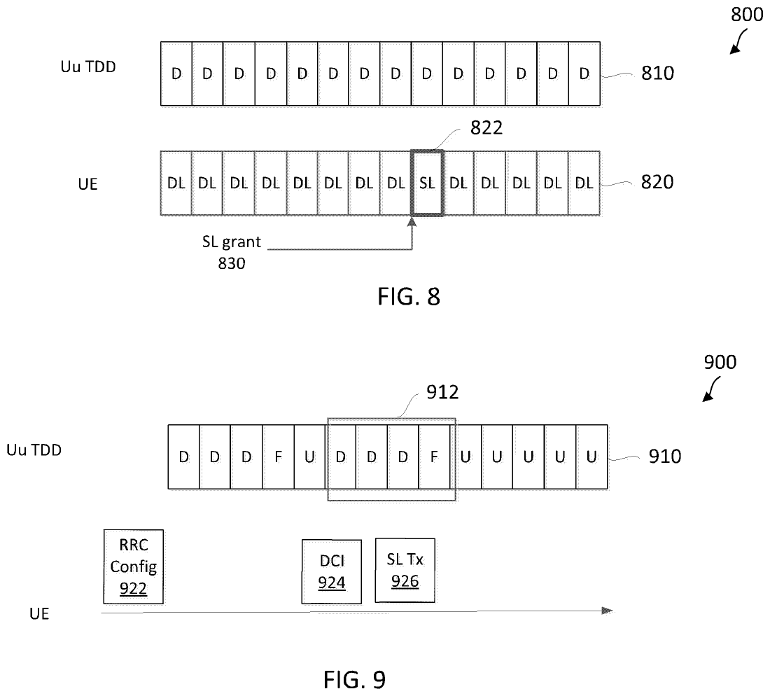

At action 706, the network entity 105 transmits, and the first UE 115a receives, a communication signal. The communication signal may include, for example DCI, and RRC information element, and/or any other suitable communication. In some aspects, the communication signal transmitted at action 706 includes additional time domain and/or priority information used by the first UE 115a to determine a priority of colliding communications. For example, the DCI may include a grant for Uu resources, a grant for SL resources, a slot format indicator (SFI), or an indicator assigning flexible time resources as either DL, UL, or SL resources. Additional details of the communication signal of action 706 will be described below and with respect to FIGS. 8 to 11.

At action 708, the method 700 includes the first UE 115a determining, based on the first time domain configuration, the second time domain configuration, an intra-band priority configuration, and the communication signal of action 706, the intra-band priorities of a first communication and a second communication. In some aspects, the second communication may be scheduled such that it at least partially overlaps with the first communication. In some aspects, one of the first communication or the second communication comprises an SL communication in a first link direction. In another aspect, the other of the first communication or the second communication comprises a Uu communication for a second link direction opposite the first link direction. In some aspects, the first link direction is a transmitting direction and the second link direction is a receiving link direction.

In some aspects, the first communication and the second communication may be described as colliding in time, where the first communication and second communication are scheduled and/or configured to be communicated in a same time period. The first communication in the second communication may only partially overlap in some instances. In other instances, the first communication in the second communication completely overlap in time. Because the first communication is associated with a first link direction and the second communication is associated with a second link direction opposite the first link direction, the first communication and the second communication may not be communicated at a same time. In this regard, the UE may not be capable of or configured to transmit a Uu communication at the same time as receiving a SL communication, and vice versa. The intra-band priority configuration may indicate or provide for the termination the relative priorities of the first communication and the second communication. For example, in some aspects, the intra-band priority configuration may include or indicate one or more rules for resolving collisions between a Uu communication and a first link direction and they SL communication and a second link direction, and in particular when the first communication and the second communication are scheduled on intra-band frequency resources. In some aspects, the intra-band priority configuration may be a static configuration or hardcoded configuration in other words, the intra-band configuration may be a preconfigured configuration at the UE. In some aspects, the intra-band configuration may include a set of rules, protocols, and/or an architecture for resolving the collision between the first communication and the second communication based on one or more parameters of each of the first communication in the second communication.

FIGS. 8-11 illustrate various schemes for determining the intra-band priorities of the first communication and the second communication, wherein the first and second communications are scheduled for overlapping time periods in intra-band frequency resources and in different link directions (Rx and Tx). Accordingly, the schemes of FIGS. 8-11 may illustrate aspects of actions 706 and 708 of the method 700. For example, type and/or content of the communication signal communicated at action 706 may be different for each of the schemes described below in FIGS. 8-11.

FIG. 8 shows a scheme 800 for determining relative priorities of the first communication and the second communication according to the method 700. In the scheme 800, the first time domain configuration may be a Uu TDD 810 for SL mode 1 operation. The UE may communicate, based on the Uu TDD 810, a plurality of communications 820. The communications 820 include a plurality of DL communications and a SL communication 822. In some aspects, the communication signal communicated at action 706 may be a DCI indicating a SL grant 830 for the SL communication 822. The first communication may be a SL communication indicated by the SL grant 830. The intra-band priority configuration may indicate or cause the UE to prioritize the SL communication based on the DCI indicating the grant of the SL resources. In some aspects, the DCI may include a DCI format 3_0. In some aspects, the intra-band priority configuration may indicate that the granted SL communication has a higher priority than any or all Uu communications. In other aspects, the intra-band priority configuration may indicate that dynamically granted Uu communications have a higher priority than the dynamically granted SL communication. In some aspects, the intra-band priority configuration may indicate that semi static or statically configured Uu communications have a lower priority than the dynamically granted SL communication. In some aspects, if the UE receives both a DCI format 3_0 indicating a SL grant 830 and another DCI indicating a Uu grant, the UE may treat this scenario as an error case. Accordingly, the intra-band priority of the granted SL communication and the Uu communication may be based on UE implementation. In some aspects, the UE may be configured to prioritize the SL communication over the Uu communication in the error case. In other aspects, the UE may be configured to prioritize the Uu communication in the error case.

The SL grant 830 may be a grant for a SL transmission. Based on receiving the SL grant 830 for SL transmission, the UE may not receive DL communications in the Uu CC in the time resources associated with the SL grant 830. In another aspect, the SL grant 830 may include or indicate a reverse-link SL grant for a SL reception. In this regard, a SL grant may be a forward link or a reverse link, in some aspects. A forward link may refer to a sidelink in a transmission direction from a relay UE to a remote UE. A reverse link may refer to a sidelink in a transmission direction from a remote UE to a relay UE. For example, a remote UE may be preconfigured with a sidelink resource pool for reverse-link transmissions, and a relay UE may transmit sidelink resource pool information to the remote UE to control resource usages in the sidelink resource pool. For instance, the sidelink resource pool may include a set of resources that may be used for sidelink transmission by the remote UE over the reverse link. The sidelink resource pool information can include a variety of parameters that can control how the remote UE may select a resource from the set of resources for a reverse link transmission. With respect to the scheme 800, the reverse link in the SL grant 830 may indicate Rx resources for a communication 822 to the UE from a second SL UE.

In some aspects, a reverse-link grant may refer to a grant from the network via a network entity to a SL UE indicating resources for a reception of an SL communication to the UE. Based on receiving the reverse-link SL grant 830, the UE may refrain from transmitting UL communications in the Uu CC in the time resources associated with the grant 830.

FIG. 9 shows a scheme 900 for determining relative priorities of the first communication and the second communication according to the method 700. In the scheme 900, the first time domain configuration may include a Uu TDD 910. The Uu TDD 910 may include a set of flexible resources 912 configurable for SL transmission or DL reception. In some aspects, the communication signal received at action 706 includes a RRC configuration 922 indicating the set of flexible resources of at least one of the first time domain configuration or the second time domain configuration. The scheme 900 may further include receiving DCI 924 validating the set of flexible resources 912 for either SL transmission or DL reception. For example, the flexible resources 912 may include DL and/or flexible slots as indicated in the first time domain configuration. In some aspects, the RRC configuration 922 configuring the soft or flexible resources may indicate that the soft or flexible resources such that they do not overlap with or collide with system information, including the master information block (MIB), and/or the system information blocks (SIBs). In some aspects, the DCI 924 validating the soft or flexible resources for either SL or Uu communications may be received in a group common PDCCH. In other aspects, the DCI 924 may be received in a dedicated PDCCH. In some aspects, the DCI 924 may indicate a grant of DL resources to invalidate SL transmission in DL resources that at least partially overlap with the dynamic DL granted resources. In other aspects, the network may communicate the DCI 924 indicating a UL grant to validate a SL transmission 926 in the hard configured DL resources, if at least a part of the SL transmission 926 overlaps with the UL granted resources.

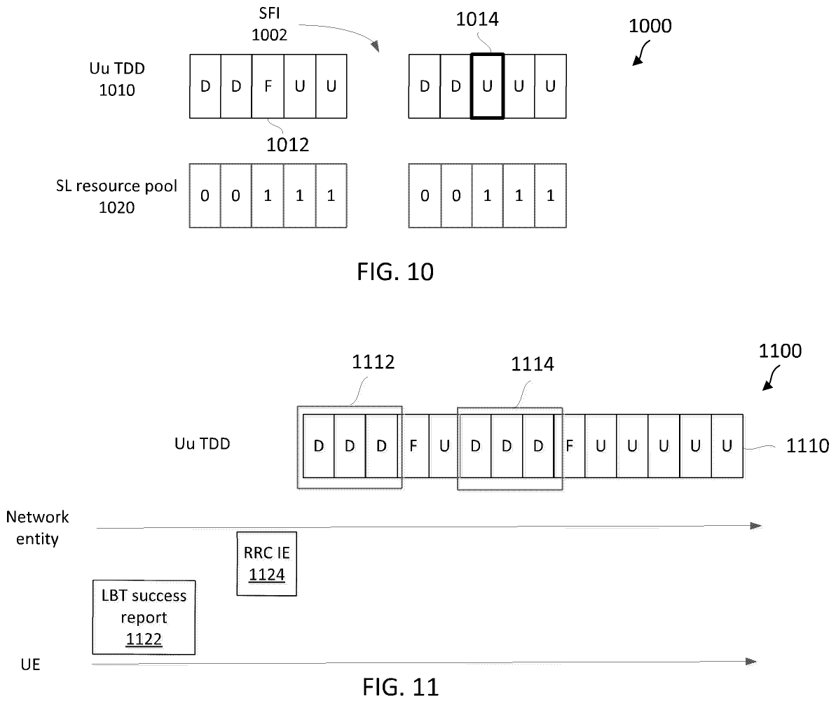

FIG. 10 shows a scheme 1000 for determining relative priorities of the first communication and the second communication according to the method 700. In the scheme 1000, the first time domain configuration 1010 may indicate one or more UL resources and one or more flexible resources. The flexible resources 1012 may be contiguous in time with the UL resources. In another aspect, the flexible resources 1012 may be spaced from the UL resources in time. The scheme 1000 may further include receiving a SFI 1002 indicating that at least a portion of the flexible resources 1012 comprises additional UL resources 1014. In other words, the SFI 1002 may convert the flexible resources 1012 to additional UL resources 1014. In some aspects, the UE may transmit, based on the SFI 1002, a SL communication using the UL resources and the additional UL resources 1014. Accordingly, the pool of SL resources 1020 may be extended by the SFI 1002. For example, the network may provide, via a network entity, the Uu TDD configuration 1010 to the UE. The SL resource pool 1020 may be confined within UL slots and flexible slots or symbols. If SFI is configured, and the SL resources overlap with flexible Uu symbols, the flexible Uu symbols can also be used for SL if the SFI 1002 indicates that the flexible symbols are UL symbols. In some aspects, the SFI 1002 may extend SL Rx resources. In another aspect, the SFI 1002 may extend SL Tx resources. In some aspects, the SL resources may overlap with at least one flexible symbol. The UE may be configured to monitor for sidelink control information (SCI), even if the DCI including the SFI has not been received and/or decoded. In other aspects, the Rx SL resources may be confined in DL and flexible slots and symbols. In some aspects, the UE may use the flexible resources if the SFI 1002 confirms the flexible symbols to be DL symbols.

FIG. 11 shows a scheme 1100 for determining relative priorities of the first communication and the second communication according to the method 700. In the scheme 1100, the first time domain configuration 1110 may indicate a plurality of DL slots. The method 700 may further include performing one or more listen-before-talks (LBTs), and transmitting, based on the LBTs, one or more LBT success reports. According to the scheme 1100, the UE may transmit a LBT success report 1122 to the network. The scheme 1100 may further include the UE receiving, based on the LBT success report 1122, a RRC IE 1124 including or indicating a resource split configuration. The resource split configuration may indicate that a portion of the plurality of DL slots are allocated for either a SL transmission or a DL reception. In some aspects, the UE may communicate the first communication based on the resource split configuration. In some aspects, the LBT success report 1122 may indicate an LBT success rate. The LBT success rate may be obtained by the UE by counting the successful LBT attempts made for SL transmission in the past t seconds. In some aspects, the LBT success rate can be compared with a threshold by the network, such as by a network entity. In some aspects, if the LBT success rate is smaller than the threshold, the network may provide the resource split configuration indicating that the following N DL slots 1112 are allocated for SL transmission, and that the remaining DL slots 1114 are allocated for DL reception. If the LBT success rate is greater than or equal to the threshold, the network may provide the resource split configuration indicating that the following N DL 1112 slots are allocated for DL reception, and that the remaining DL slots 1114 are allocated for SL transmission.

In another aspect, the LBT success report 1122 may indicate an actual transmission rate. For example, the actual transmission rate may be obtained by the UE by counting the actual SL transmissions, and diving the number of actual SL transmissions by the number of successful LBT attempts for SL transmission in the past t seconds. In some aspects, the actual transmission rate may be compared with a threshold by the network. For example if a network entity determines that the actual transmission rate is smaller than the threshold, the resource split configuration may indicate that the following N DL slots 1112 may be used for SL transmission, and that the remaining DL slots 1114 may be used for DL reception. If the network entity determines that the actual transmission rate is greater than or equal to the threshold, the resource split configuration may indicate that the following N DL slots 1112 may be used for DL reception, and that the remaining DL slots 1114 may be used for SL transmission. In some aspects, the network may be configured to refrain from transmitting DL communications in the symbols allocated for SL transmission by the resource split configuration.

Referring to FIG. 7, according to another aspect, the intra-band priority configuration may indicate priorities for colliding intra-band SL and Uu communications based on the traffic priorities of each colliding communication. For example, the intra-band priority configuration may indicate a first intra-band priority for a first traffic priority associated with the first communication, and a second intra-band priority for a second traffic priority associated with the second communication. In some aspects, the communication signal communicated at action 706 may include a DCI scheduling a Uu communication or a SL communication. In another aspect, the communication signal communicated at action 706 may include a SCI scheduling a SL transmission and/or a SL reception. In one example, for cross-slot scheduling, the intra-band priority may be based on whether an ultra-reliable low latency communication (URLLC) priority threshold is configured or provided. For example, the intra-band priority of colliding intra-band SL and Uu communications may be based on whether sl-PriorityThreshold-DL-URLLC is configured. If sl-Priority Threshold-DL-URLLC is configured, and if one of the first communication or the second communication includes DL URLLC traffic, an SL transmission may have a higher intra-band priority than the scheduled DL URLLC configuration if the priority value of the SL transmission is smaller than sl-PriorityThreshold-DL-URLLC. It will be understood that a smaller priority value may indicate a higher priority of communication. For example, a communication having a priority value of 1 may be higher priority than a communication having a priority of 2. Otherwise, the DL URLLC communication may have a higher intra-band priority. The UE may be configured to refrain from communicating the lower intra-band priority communication. If sl-Priority Threshold-DL-URLLC is not configured, the DL URLLC transmission may have higher priority. Further, if the colliding DL communication does not include URLLC traffic, the intra-band priority configuration may indicate that the SL transmission has higher priority than the DL reception if the priority value of the SL transmission is smaller than a sidelink priority threshold. For example, the UE may be configured with sl-PriorityThreshold-DL. If the priority value of the SL transmission is smaller than sl-PriorityThreshold-DL, the SL transmission may have the higher intra-band priority. Otherwise, the DL reception may have the higher priority. The UE may communicate the communication having the higher intra-band priority, and may refrain from communicating the communication having the lower intra-band priority. In another aspect, the network may control which of the SL communication or the DL communication is given priority at the UE by setting the priority values of the SL communication and/or the DL communication relative to the configured thresholds described above.

Returning to FIG. 7, at actions 710/712, the first UE 115a communicates, with the network via the network entity 105, the first communication. The dashed lines represent alternatives or variations that may be provided by the method 700. For example, actions 710/712 may involve receiving a DL communication from the network entity 105, transmitting a UL communication to the network entity 105, transmitting a SL communication to the second UE 115b, or receiving a SL communication from the second UE 115b. In some aspects, actions 710/712 may involve or include refraining from communicating the second communication colliding with the first communication. As explained above, the communicating the first communication may be based on the first time domain configuration, the second time domain configuration, and the intra-band priority configuration.

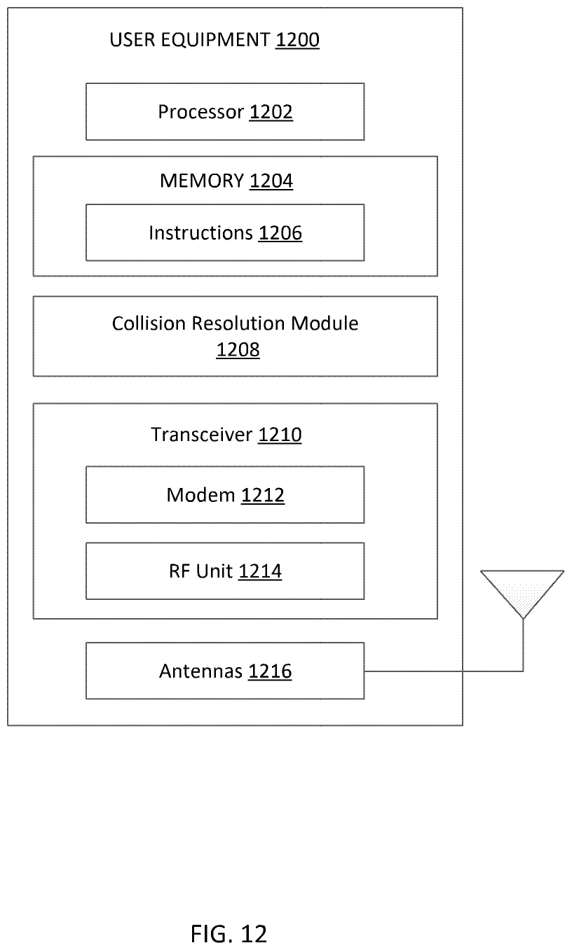

FIG. 12 is a block diagram of an exemplary UE 1200 according to some aspects of the present disclosure. The UE 1200 may be the UE 115 in the network 100 or 300 as discussed above. As shown, the UE 1200 may include a processor 1202, a memory 1204, a Collision resolution module 1208, a transceiver 1210 including a modem subsystem 1212 and a radio frequency (RF) unit 1214, and one or more antennas 1216. These elements may be coupled with each other and in direct or indirect communication with each other, for example via one or more buses.

The processor 1202 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1202 may also be implemented as a combination of computing devices, e.g., a combination of a DSP and a microprocessor, a plurality of microprocessors, one or more microprocessors in conjunction with a DSP core, or any other such configuration.

The memory 1204 may include a cache memory (e.g., a cache memory of the processor 1202), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 1204 includes a non-transitory computer-readable medium. The memory 1204 may store instructions 1206. The instructions 1206 may include instructions that, when executed by the processor 1202, cause the processor 1202 to perform the operations described herein with reference to the UEs 115 in connection with aspects of the present disclosure, for example, aspects of FIGS. 7-11 and 14. Instructions 1206 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The Collision resolution module 1208 may be implemented via hardware, software, or combinations thereof. For example, the Collision resolution module 1208 may be implemented as a processor, circuit, and/or instructions 1206 stored in the memory 1204 and executed by the processor 1202.

In some aspects, the Collision resolution module 1208 may be configured to perform aspects of FIGS. 7-11 and 14. In this regard, the Collision resolution module 1208 may be configured to receive a first time domain configuration for a Uu component carrier (CC), and receive a second time domain configuration for a SL resource pool. In some aspects, the Uu CC and the SL resource pool are within a same frequency band. In some aspects, the Collision resolution module 1208 may be configured to communicate, based on the first time domain configuration, the second time domain configuration, and an intra-band priority configuration, a first communication at a first time period. In some aspects, a second communication is scheduled for at least a portion of the first time period, and one of the first communication or the second communication comprises an SL communication in a first link direction. In another aspect, the other of the first communication or the second communication comprises a Uu communication for a second link direction opposite the first link direction.

As shown, the transceiver 1210 may include the modem subsystem 1212 and the RF unit 1214. The transceiver 1210 can be configured to communicate bi-directionally with other devices, such as the BSs 105 and/or the UEs 115. The modem subsystem 1212 may be configured to modulate and/or encode the data from the memory 1204 and the Collision resolution module 1208 according to a modulation and coding scheme (MCS), e.g., a low-density parity check (LDPC) coding scheme, a turbo coding scheme, a convolutional coding scheme, a digital beamforming scheme, etc. The RF unit 1214 may be configured to process (e.g., perform analog to digital conversion or digital to analog conversion, etc.) modulated/encoded data from the modem subsystem 1212 (on outbound transmissions) or of transmissions originating from another source such as a UE 115 or a BS 105. The RF unit 1214 may be further configured to perform analog beamforming in conjunction with the digital beamforming. Although shown as integrated together in transceiver 1210, the modem subsystem 1212 and the RF unit 1214 may be separate devices that are coupled together to enable the UE 1200 to communicate with other devices.

The RF unit 1214 may provide the modulated and/or processed data, e.g. data packets (or, more generally, data messages that may contain one or more data packets and other information), to the antennas 1216 for transmission to one or more other devices. The antennas 1216 may further receive data messages transmitted from other devices. The antennas 1216 may provide the received data messages for processing and/or demodulation at the transceiver 1210. The antennas 1216 may include multiple antennas of similar or different designs in order to sustain multiple transmission links. The RF unit 1214 may configure the antennas 1216.

In some instances, the UE 1200 can include multiple transceivers 1210 implementing different RATs (e.g., NR and LTE). In some instances, the UE 1200 can include a single transceiver 1210 implementing multiple RATs (e.g., NR and LTE). In some instances, the transceiver 1210 can include various components, where different combinations of components can implement RATs.

In some aspects, the processor 1202 may be coupled to the memory 1204, the Collision resolution module 1208, and/or the transceiver 1210. The processor 1202 and may execute operating system (OS) code stored in the memory 1204 in order to control and/or coordinate operations of the Collision resolution module 1208 and/or the transceiver 1210. In some aspects, the processor 1202 may be implemented as part of the Collision resolution module 1208.

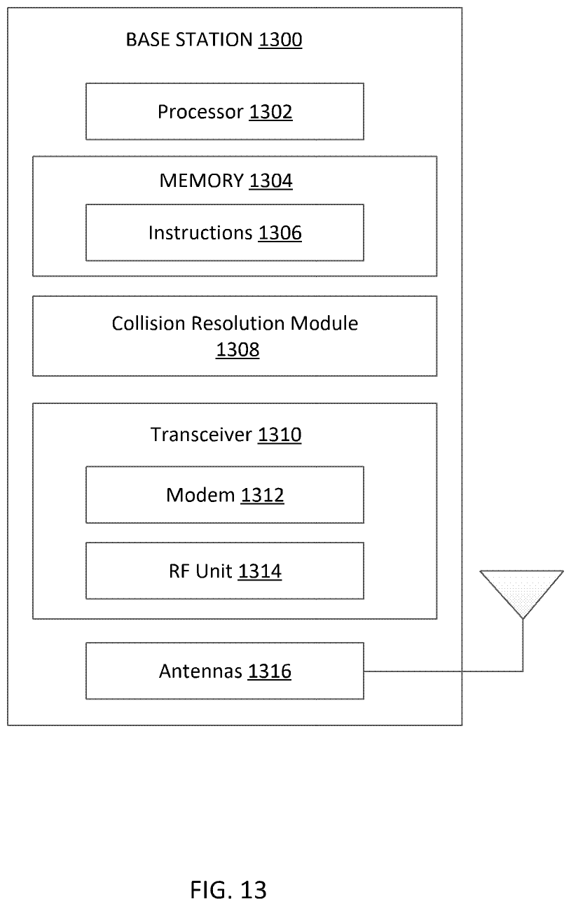

FIG. 13 is a block diagram of an exemplary BS 1300 according to some aspects of the present disclosure. The BS 1300 may be a BS 105 as discussed above. As shown, the BS 1300 may include a processor 1302, a memory 1304, a Collision resolution module 1308, a transceiver 1310 including a modem subsystem 1312 and a RF unit 1314, and one or more antennas 1316. These elements may be coupled with each other and in direct or indirect communication with each other, for example via one or more buses.

The processor 1302 may have various features as a specific-type processor. For example, these may include a CPU, a DSP, an ASIC, a controller, a FPGA device, another hardware device, a firmware device, or any combination thereof configured to perform the operations described herein. The processor 1302 may also be implemented as a combination of computing devices, e.g., a combination of a DSP and a microprocessor, a plurality of microprocessors, one or more microprocessors in conjunction with a DSP core, or any other such configuration.

The memory 1304 may include a cache memory (e.g., a cache memory of the processor 1302), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 1304 may include a non-transitory computer-readable medium. The memory 1304 may store instructions 1306. The instructions 1306 may include instructions that, when executed by the processor 1302, cause the processor 1302 to perform operations described herein, for example, aspects of FIGS. 7-11 and 15. Instructions 1306 may also be referred to as code, which may be interpreted broadly to include any type of computer-readable statement(s).

The Collision resolution module 1308 may be implemented via hardware, software, or combinations thereof. For example, the Collision resolution module 1308 may be implemented as a processor, circuit, and/or instructions 1306 stored in the memory 1304 and executed by the processor 1302.

The Collision resolution module 1308 may be used for various aspects of the present disclosure, for example, aspects of FIGS. 7-11 and 15. In some aspects, the Collision resolution module 1308 may be configured to transmit a first time domain configuration for a Uu component carrier (CC), transmit a second time domain configuration for a SL resource pool. In some aspects, the Uu CC and the SL resource pool are within a same frequency band. In some aspects, the Collision resolution module 1308 may be configured to communicate, based on the first time domain configuration, the second time domain configuration, and an intra-band priority configuration, a first communication at a first time period. In some aspects, a second communication is scheduled for at least a portion of the first time period, and one of the first communication or the second communication comprises an SL communication in a first link direction. In another aspect, the other of the first communication or the second communication comprises a Uu communication for a second link direction opposite the first link direction.

Additionally or alternatively, the Collision resolution module 1308 can be implemented in any combination of hardware and software, and may, in some implementations, involve, for example, processor 1302, memory 1304, instructions 1306, transceiver 1310, and/or modem 1312.

As shown, the transceiver 1310 may include the modem subsystem 1312 and the RF unit 1314. The transceiver 1310 can be configured to communicate bi-directionally with other devices, such as the UEs 115 and/or 1200. The modem subsystem 1312 may be configured to modulate and/or encode data according to a MCS, e.g., a LDPC coding scheme, a turbo coding scheme, a convolutional coding scheme, a digital beamforming scheme, etc. The RF unit 1314 may be configured to process (e.g., perform analog to digital conversion or digital to analog conversion, etc.) modulated/encoded data from the modem subsystem 1312 (on outbound transmissions) or of transmissions originating from another source such as a UE 115 or UE 1200. The RF unit 1314 may be further configured to perform analog beamforming in conjunction with the digital beamforming. Although shown as integrated together in transceiver 1310, the modem subsystem 1312 and/or the RF unit 1314 may be separate devices that are coupled together at the BS 1300 to enable the BS 1300 to communicate with other devices.

The RF unit 1314 may provide the modulated and/or processed data, e.g. data packets (or, more generally, data messages that may contain one or more data packets and other information), to the antennas 1316 for transmission to one or more other devices. This may include, for example, a configuration indicating a plurality of sub-slots within a slot according to aspects of the present disclosure. The antennas 1316 may further receive data messages transmitted from other devices and provide the received data messages for processing and/or demodulation at the transceiver 1310. The antennas 1316 may include multiple antennas of similar or different designs in order to sustain multiple transmission links.

In some instances, the BS 1300 can include multiple transceivers 1310 implementing different RATs (e.g., NR and LTE). In some instances, the BS 1300 can include a single transceiver 1310 implementing multiple RATs (e.g., NR and LTE). In some instances, the transceiver 1310 can include various components, where different combinations of components can implement RATs.

In some aspects, the processor 1302 may be coupled to the memory 1304, the Collision resolution module 1308, and/or the transceiver 1310. The processor 1302 may execute OS code stored in the memory 1304 to control and/or coordinate operations of the Collision resolution module 1308, and/or the transceiver 1310. In some aspects, the processor 1302 may be implemented as part of the Collision resolution module 1308. In some aspects, the processor 1302 is configured to transmit via the transceiver 1310, to a UE, an indicator indicating a configuration of sub-slots within a slot.

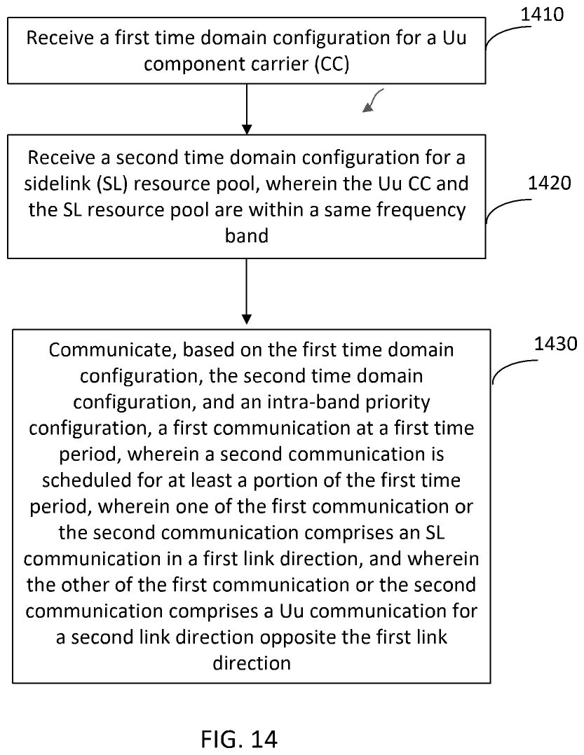

FIG. 14 is a flow diagram of a communication method 1400 according to some aspects of the present disclosure. Aspects of the method 1400 can be executed by a computing device (e.g., a processor, processing circuit, and/or other suitable component) of a wireless communication device or other suitable means for performing the actions. For example, a wireless communication device, such as the UE 115 or the UE 1200, may utilize one or more components, such as the processor 1202, the memory 1204, the Collision resolution module 1208, the transceiver 1210, the modem 1212, and the one or more antennas 1216, to execute aspects of method 1400. The method 1400 may employ similar mechanisms as in the networks 100 and 300 and the aspects and actions described with respect to FIGS. 7-11. As illustrated, the method 1400 includes a number of enumerated actions, but the method 1400 may include additional actions before, after, and in between the enumerated actions. In some aspects, one or more of the enumerated actions may be omitted or performed in a different order.

At action 1410, the method 1400 includes a UE (e.g., the UE 115 or the UE 1200) receiving a first time domain configuration for a Uu component carrier (CC). In some aspects, action 1410 includes the UE receiving the first time domain configuration from a network entity. For example, the UE may receive the first time domain configuration from a base station (BS). In some aspects, the network entity may include a portion of a disaggregated BS. In some aspects, the first time domain configuration includes a first time division duplexing (TDD) configuration for the Uu carrier. The first time domain configuration may indicate one or more downlink (DL) slots, one or more uplink (UL) slots, and/or one or more flexible (F) slots. In some aspects, the first time domain configuration may indicate one or more DL symbols of a slot, one or more UL symbols of a slot, and/or one or more flexible symbols of a slot.

The first time domain configuration may be static, semi-static, and/or dynamic. For example, in some aspects, receiving the first time domain configuration may include receiving a radio resource control (RRC) information element (IE) indicating one or more slot and/or symbol patterns for one or more slots. RRC IE may include a TDD pattern index associated with a pattern of DL, UL, and or F slots. In some aspects, the first time domain configuration may be a cell-level configuration common to a plurality of UEs operating in the cell. In another example, the first time domain configuration may be a dedicated configuration specific to the UE. In another aspect, receiving the first time domain configuration may include receiving downlink control information (DCI) dynamically indicating the TDD. In some aspects, the DCI may include DCI format 2_0. The DCI format 2_0 may include one or more slot format indicators (SFIs) for a group of UEs, or for individual UEs, such as the UE of the method 1400.

At action 1420, the method 1400 includes the UE receiving a second time domain configuration for sidelink (SL) resource pool. In some aspects, action 1420 includes the UE receiving the second time domain configuration from a network entity. For example, the UE may receive the second time domain configuration from a base station (BS). In some aspects, the network entity may include a portion of a disaggregated BS. In some aspects, the second time domain configuration includes a second time division duplexing (TDD) configuration for the SL resource pool. The second time domain configuration may include a bitmap. In another aspect, the second time domain configuration may include a SL resource pool grant, a semi-static configuration, and/or any other suitable type of configuration. In some aspects, receiving the second time domain configuration may include receiving a SL grant from another UE, or from a network device.

The second time domain configuration may be static, semi-static, and/or dynamic. For example, in some aspects, receiving the second time domain configuration may include receiving a radio resource control (RRC) information element (IE) indicating one or more slot and/or symbol patterns for one or more slots. The RRC IE may include or indicate a TDD pattern index associated with a pattern of DL, UL, and or F slots. In some aspects, the second time domain configuration may be a cell-level configuration common to a plurality of UEs operating in the cell. In another example, the second time domain configuration may be a dedicated configuration specific to the UE. In another aspect, receiving the second time domain configuration may include receiving downlink control information (DCI) dynamically indicating the TDD. In some aspects, the DCI may include DCI format 2_0. The DCI format 2_0 may include one or more slot format indicators (SFIs) for a group of UEs, or for individual UEs, such as the UE of the method 1400.

In some aspects, the Uu CC and the SL resource pool are within a same frequency band. In some aspects, the SL resource pool may be referred to as a SL CC, a SL carrier, and/or a SL BWP. In some aspects, the Uu CC and the SL resource pool may be described as intra-band. However, it will be understood that the Uu CC and the SL resource pool may not overlap in frequency in some aspects. In other aspects, the Uu CC and the SL resource pool may at least partially overlap in frequency. In some aspects, the SL resource pool may include a set of unlicensed frequency resources. In some aspects, the Uu CC may include one or more licensed component carriers or frequency bands. In other aspects, both the SL resource pool and the Uu CC are in an unlicensed frequency band.

At action 1430, the method 1400 includes the UE communicating, based on the first time domain configuration, the second time domain configuration, and an intra-band priority configuration, a first communication at a first time period. In some aspects, a second communication is scheduled for at least a portion of the first time period. In other words, the second communication may be scheduled such that it at least partially overlaps with the first communication. In some aspects, one of the first communication or the second communication comprises an SL communication in a first link direction. In another aspect, the other of the first communication or the second communication comprises a Uu communication for a second link direction opposite the first link direction. In some aspects, the first link direction is a transmitting direction and the second link direction is a receiving link direction. For example, communicating in the first link direction may include the UE transmitting a UL communication or a SL communication. Communicating in the second link direction may include the UE receiving DL communication or receiving a SL communication. In another aspect, the first link direction is a receiving direction and the second link direction is a transmitting direction. Accordingly, in some aspects, action 1430 includes the UE transmitting the first communication. In another aspect, action 1430 includes the UE receiving the first communication. The first communication may be a Uu communication or a SL communication.

Communicating the first communication may include receiving a DL signal or communication. For example, communicating the first communication may include receiving DCI, DL data in a PDSCH, a DL reference signal, synchronization signals, system information, broadcast information, and/or any other suitable DL communication. In another aspect, communication the first communication may include transmitting a UL signal or communication. For example, communication the first communication may include transmitting uplink control information (UCI), UL data in a PUSCH, HARQ feedback information, UL reference signals, UL synchronization signals, and/or any other suitable type of communication. In another aspect, communication the first communication may include receiving a SL communication. For example, communicating the first communication may include receiving a physical sidelink control channel (PSCCH) signal, a physical sidelink shared channel (PSSCH) signal, and/or a physical sidelink feedback channel (PSFCH) signal. In another aspect, communicating the first communication may include transmitting a SL communication. For example, communicating the first communication may include transmitting a PSCCH signal, a PSSCH signal, and/or a PSFCH signal. In other aspects, communicating the first communication may include transmitting or receiving a SL reference signal and/or a SL synchronization signal.

In some aspects, the first communication and the second communication may be described as colliding in time, where the first communication and second communication are scheduled and/or configured to be communicated in a same time period. The first communication in the second communication may only partially overlap in some instances. In other instances, the first communication in the second communication completely overlap in time. Because the first communication is associated with a first link direction and the second communication is associated with a second link direction opposite the first link direction, the colliding communications may not be communicated at a same time. In this regard, the UE may not be capable of or configured to transmit a Uu communication at the same time as receiving a SL communication, and vice versa. The intra-band priority configuration may indicate or provide for the termination the relative priorities of the first communication and the second communication. For example, in some aspects, the intra-band priority configuration may include or indicate one or more rules for resolving collisions between a Uu communication and a first link direction and they SL communication and a second link direction, and in particular when the first communication and the second communication are scheduled on intra-band frequency resources. In some aspects, the intra-band priority configuration may be a static configuration or hardcoded configuration in other words, the intra-band configuration may be a preconfigured configuration at the UE. In some aspects, the intra-band configuration may include a set of rules, protocols, and/or an architecture for resolving the collision between the first communication and the second communication based on one or more parameters of each of the first communication in the second communication. For example, the intra-band configuration may include or provide the schemes described above with respect to FIGS. 7-11.

For example, in some aspects, the first communication may be a SL communication indicated by a grant of SL resources received in DCI. The intra-band priority configuration may indicate or cause the UE to prioritize the SL communication based on the DCI indicating the grant of the SL resources. In some aspects, the DCI may include a DCI format 3_0. In some aspects, the intra-band priority configuration may indicate that the granted SL communication has a higher priority than any or all Uu communications. In other aspects, the intra-band priority configuration may indicate that dynamically granted Uu communications have a higher priority than the dynamically granted SL communication. In some aspects, the intra-band priority configuration may indicate that semi static or statically configured Uu communications have a lower priority than the dynamically granted SL communication.

In some aspects, the first time domain configuration may indicate a set of flexible resources configurable for SL transmission or DL reception. In some aspects, the method 1400 further includes receiving, from a network entity, DCI validating the set of flexible resources for either SL transmission or DL reception. For example, the flexible resources may include DL and/or flexible slots as indicated in the first time domain configuration. In this regard, the method 1400 may include the UE receiving a hard Uu TDD configuration including Uu DL slots and/or symbols. In some aspects, the method may further include receiving a hard SL TDD configuration including hard SL Tx and/or Rx resources. Receiving the first time domain configuration may include receiving DCI indicating the flexible resources. In some aspects, the method 1400 may include receiving, from a network entity, an RRC configuration configuring the soft or flexible resources for SL Tx and/or Uu DL. In some aspects, the RRC configuration configuring the soft or flexible resources may indicate that the soft or flexible resources such that they do not overlap with or collide with system information, including the master information block (MIB), and/or the system information blocks (SIBs). In some aspects, the DCI indicating the soft or flexible resources may be received in a group common PDCCH. In other aspects, the DCI may be received in a dedicated PDCCH. In some aspects, the network may communicate DCI indicating a grant of DL resources to invalidate SL transmission in DL resources that at least partially overlap with the dynamic DL granted resources. In other aspects, the network may communicate DCI indicating a UL grant to validate SL transmission in the hard configured DL resources, if at least a part of the SL transmission overlaps with the UL granted resources.

In another aspect, the first time domain configuration may indicate one or more UL resources and one or more flexible resources. The flexible resources may be contiguous in time with the UL resources. In another aspect, the flexible resources may be spaced from the UL resources in time. The method 1400 may further include receiving a SFI indicating that at least a portion of the flexible resources comprises additional UL resources. In some aspects, the communicating the first communication comprises transmitting, based on the SFI, a SL communication using the UL resources and the additional UL resources. Accordingly, the pool of SL resources may be extended by SFI. For example, the network may provide, via a network entity, a Uu TDD configuration to the UE. The SL resource pool may be confined within UL slots and flexible slots or symbols. If SFI is configured, and the SL resource overlap with flexible Uu symbols, the flexible Uu symbols can also be used for SL if the SFI indicates that the flexible symbols are UL symbols. In some aspects, the SFI may extend SL Rx resources. In another aspect, the SFI may extend SL Tx resources. In some aspects, the SL resource may overlap with at least one flexible symbol. The UE may be configured to monitor for sidelink control information (SCI), even if the DCI including the SFI has not been received and/or decoded. In other aspects, the Rx SL resources may be confined in DL and flexible slots and symbols. In some aspects, the UE may use the flexible resources if the SFI confirms the flexible symbols to be DL symbols.

In some aspects, the first time domain configuration may indicate a plurality of DL slots. The method 1400 may further include performing one or more listen-before-talks (LBTs), and transmitting, based on the LBTs, one or more LBT success reports. The method 1400 may further include the network transmitting and the UE receiving, based on the one or more LBT success reports, a resource split configuration. The resource split configuration may indicate that a portion of the plurality of DL slots are allocated for either a SL transmission or a DL reception. In some aspects, the communicating the first communication may be further based on the resource split configuration. The resource split configuration may be a semi-static configuration, in some aspects. For example, the network may transmit, to the UE, a RRC information element (IE) including or indicating the resource split configuration. In some aspects, the one or more LBT success reports may indicate an LBT success rate. The LBT success rate may be obtained by the UE by counting the successful LBT attempts made for SL transmission in the past t seconds. In some aspects, the LBT success rate can be compared with a threshold by the network, such as by a network entity. In some aspects, if the LBT success rate is smaller than the threshold, the network may provide the resource split configuration indicating that the following N DL slots are allocated for SL transmission. If the LBT success rate is greater than or equal to the threshold, the network may provide the resource split configuration indicating that the following N DL slots are allocated for DL reception.

In another aspect, the one or more LBT success reports may indicate an actual transmission rate. For example, the actual transmission rate may be obtained by the UE by counting the actual SL transmissions, and diving the number of actual SL transmissions by the number of successful LBT attempts for SL transmission in the past t seconds. In some aspects, the actual transmission rate may be compared with a threshold by the network. For example if a network entity determines that the actual transmission rate is smaller than the threshold, the resource split configuration may indicate that the following N DL slots may be used for SL transmission. If the network entity determines that the actual transmission rate is greater than or equal to the threshold, the resource split configuration may indicate that the following N DL slots may be used for DL reception. In some aspects, the network may be configured to refrain from transmitting DL communications in the symbols allocated for SL transmission by the resource split configuration.

In another aspect, the intra-band priority configuration may indicate priorities for colliding intra-band SL and Uu communications based on the traffic priorities of each colliding communication. For example, the intra-band priority configuration may indicate a first intra-band priority for a first traffic priority associated with the first communication, and a second intra-band priority for a second traffic priority associated with the second communication. In one example, for cross-slot scheduling, the intra-band priority may be based on whether a URLLC priority threshold is configured or provided. For example, the intra-band priority of colliding intra-band SL and Uu communications may be based on whether sl-PriorityThreshold-DL-URLLC is configured. If sl-PriorityThreshold-DL-URLLC is configured, and if one of the first communication or the second communication includes DL URLLC traffic, an SL transmission may have a higher intra-band priority than the scheduled DL URLLC configuration if the priority value of the SL transmission is smaller than sl-PriorityThreshold-DL-URLLC. It will be understood that a smaller priority value may indicate a higher priority of communication. For example, a communication having a priority value of 1 may be higher priority than a communication having a priority of 2. Otherwise, the DL URLLC communication may have a higher intra-band priority. The UE may be configured to refrain from communicating the lower intra-band priority communication. If sl-PriorityThreshold-DL-URLLC is not configured, the DL URLLC transmission may have higher priority. Further, if the colliding DL communication does not include URLLC traffic, the intra-band priority configuration may indicate that the SL transmission has higher priority than the DL reception if the priority value of the SL transmission is smaller than a sidelink priority threshold. For example, the UE may be configured with sl-PriorityThreshold-DL. If the priority value of the SL transmission is smaller than sl-PriorityThreshold-DL, the SL transmission may have the higher intra-band priority. Otherwise, the DL reception may have the higher priority. The UE may communicate the communication having the higher intra-band priority, and may refrain from communicating the communication having the lower intra-band priority. In another aspect, the network may control which of the SL communication or the DL communication is given priority at the UE by setting the priority values of the SL communication and/or the DL communication relative to the configured thresholds described above.

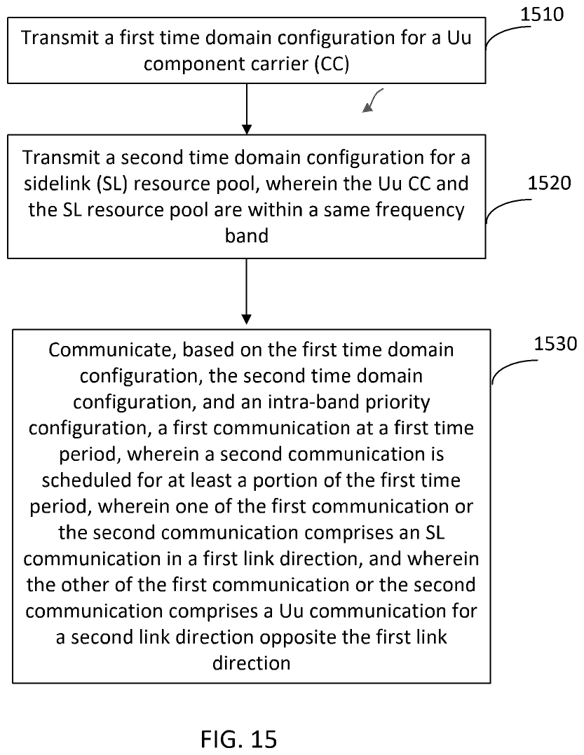

FIG. 15 is a flow diagram of a communication method 1500 according to some aspects of the present disclosure. Aspects of the method 1500 can be executed by a computing device (e.g., a processor, processing circuit, and/or other suitable component) of a wireless communication device or other suitable means for performing the actions. For example, a wireless communication device, such as the BS 105 or the BS 1300, may utilize one or more components, such as the processor 1302, the memory 1304, the Collision resolution module 1308, the transceiver 1310, the modem 1312, and the one or more antennas 1316, to execute aspects of method 1500. The method 1500 may employ similar mechanisms as in the networks 100 and 300 and the aspects and actions described with respect to FIGS. 7-11. As illustrated, the method 1500 includes a number of enumerated actions, but the method 1500 may include additional actions before, after, and in between the enumerated actions. In some aspects, one or more of the enumerated actions may be omitted or performed in a different order.

At action 1510, the method 1500 includes a network entity (e.g., BS 105, RU 240, DU 230, and/or a CU 250) transmitting a first time domain configuration for a Uu component carrier (CC). In some aspects, action 1510 includes the network entity transmitting the first time domain configuration to a UE. In some aspects, the network entity may include a portion of a disaggregated BS. In some aspects, the first time domain configuration includes a first time division duplexing (TDD) configuration for the Uu carrier. The first time domain configuration may indicate one or more downlink (DL) slots, one or more uplink (UL) slots, and/or one or more flexible (F) slots. In some aspects, the first time domain configuration may indicate one or more DL symbols of a slot, one or more UL symbols of a slot, and/or one or more flexible symbols of a slot.

The first time domain configuration may be static, semi-static, and/or dynamic. For example, in some aspects, transmitting the first time domain configuration may include transmitting a radio resource control (RRC) information element (IE) indicating one or more slot and/or symbol patterns for one or more slots. RRC IE may include a TDD pattern index associated with a pattern of DL, UL, and or F slots. In some aspects, the first time domain configuration may be a cell-level configuration common to a plurality of UEs operating in the cell. In another example, the first time domain configuration may be a dedicated configuration specific to the UE. In another aspect, transmitting the first time domain configuration may include transmitting downlink control information (DCI) dynamically indicating the TDD. In some aspects, the DCI may include DCI format 2_0. The DCI format 2_0 may include one or more slot format indicators (SFIs) for a group of UEs, or for individual UEs, such as the UE of the method 1500.

At action 1520, the method 1500 includes the network entity transmitting a second time domain configuration for sidelink (SL) resource pool. In some aspects, action 1520 includes the network entity transmitting the second time domain configuration to the UE. In some aspects, the second time domain configuration includes a second time division duplexing (TDD) configuration for the SL resource pool. The second time domain configuration may include a bitmap.

The second time domain configuration may be static, semi-static, and/or dynamic. For example, in some aspects, transmitting the second time domain configuration may include transmitting a radio resource control (RRC) information element (IE) indicating one or more slot and/or symbol patterns for one or more slots. RRC IE may include a TDD pattern index associated with a pattern of DL, UL, and or F slots. In some aspects, the second time domain configuration may be a cell-level configuration common to a plurality of UEs operating in the cell. In another example, the second time domain configuration may be a dedicated configuration specific to the UE. In another aspect, transmitting the second time domain configuration may include transmitting downlink control information (DCI) dynamically indicating the TDD. In some aspects, the DCI may include DCI format 2_0. The DCI format 2_0 may include one or more slot format indicators (SFIs) for a group of UEs, or for individual UEs, such as the UE of the method 1500.

In some aspects, the Uu CC and the SL resource pool are within a same frequency band. In some aspects, the SL resource pool may be referred to as a SL CC, a SL carrier, and/or a SL BWP. In some aspects, the Uu CC and the SL resource pool may be described as intra-band. However, it will be understood that the Uu CC and the SL resource pool may not overlap in frequency in some aspects. In other aspects, the Uu CC and the SL resource pool may at least partially overlap in frequency. In some aspects, the SL resource pool may include a set of unlicensed frequency resources. In some aspects, the Uu CC may include one or more licensed component carriers or frequency bands. In other aspects, both the SL resource pool and the Uu CC are in an unlicensed frequency band.

At action 1530, the method 1500 includes the network entity communicating, based on the first time domain configuration, the second time domain configuration, and an intra-band priority configuration, a first communication at a first time period. In some aspects, a second communication is scheduled for at least a portion of the first time period. In other words, the second communication may be scheduled such that it at least partially overlaps with the first communication. In some aspects, first communication comprises a Uu communication in a first link direction and the second communication comprises an SL communication in a second link direction. In some aspects, the first link direction is a transmitting direction and the second link direction is a transmitting link direction. For example, communicating in the first link direction may include the network entity transmitting a DL communication, or receiving a UL communication.

The method 1500 may include aspects of FIGS. 7-11, and of the method 1400 described above. For example, communicating the first communication may include resolving a scheduling collision between an SL communication and a Uu communication scheduled on intra-brand frequency resources. In some aspects, the method 1500 may include the network entity transmitting a communication signal to the UE to resolve the collision. For example, the method 1500 may include transmitting DCI, an RRC IE, and/or any other suitable communication causing the UE to prioritize either a Uu communication (e.g., DL, UL), or a SL communication (e.g., SL Tx, SL Rx).

Communicating the first communication may include transmitting a DL signal or communication. For example, communicating the first communication may include transmitting DCI, DL data in a PDSCH, a DL reference signal, synchronization signals, system information, broadcast information, and/or any other suitable DL communication. In another aspect, communication the first communication may include receiving a UL signal or communication. For example, communication the first communication may include receiving UCI, UL data in a PUSCH, HARQ feedback information, UL reference signals, UL synchronization signals, and/or any other suitable type of communication.

Further aspects of the present disclosure include the following:

Aspect 1. A method of wireless communication performed at a user equipment (UE), the method comprising: receiving a first time domain configuration for a Uu component carrier (CC); receiving a second time domain configuration for a sidelink (SL) resource pool, wherein the Uu CC and the SL resource pool are within a same frequency band; and communicating, based on the first time domain configuration, the second time domain configuration, and an intra-band priority configuration, a first communication at a first time period, wherein a second communication is scheduled for at least a portion of the first time period, wherein one of the first communication or the second communication comprises an SL communication in a first link direction, and wherein the other of the first communication or the second communication comprises a Uu communication for a second link direction opposite the first link direction.

Aspect 2. The method of aspect 1, further comprising: receiving downlink control information (DCI) indicating a grant of SL resources, wherein the first communication comprises a SL communication and the second communication comprises a Uu communication, and wherein the communicating the first communication comprises communicating the SL communication on the SL resource pool based on the grant of SL resources.

Aspect 3. The method of aspect 2, wherein the intra-band priority configuration indicates that the SL communication has a higher priority than all Uu communications.

Aspect 4. The method of aspect 3, wherein the grant of SL resources includes a dynamic grant for a SL transmission in the SL resources.

Aspect 5. The method of aspect 3, wherein the grant of SL resources includes a reverse-link grant for a SL reception in the SL resources.

Aspect 6. The method of aspect 2, wherein the intra-band priority configuration indicates that that an intra-band priority of the second communication is based on whether the second communication is a dynamically granted Uu communication.

Aspect 7. The method of aspect 6, wherein the grant of SL resources includes a dynamic grant for a SL transmission in the SL resources.

Aspect 8. The method of aspect 6, wherein the grant of SL resources includes a reverse-link grant for a SL reception in the SL resources.

Aspect 9. The method of any of aspects 1-8, wherein the first time domain configuration indicates a set of flexible resources configurable for SL transmission or downlink (DL) reception, and wherein the method further comprises: receiving, from a network entity, downlink control information (DCI) validating the set of flexible resources for either SL transmission or DL reception.

Aspect 10. The method of any of aspects 1-9, wherein the first time domain configuration indicates one or more uplink (UL) resources and one or more flexible resources, wherein the method further comprises: receiving a slot format indicator (SFI) indicating that at least a portion of the one or more flexible resources comprises additional UL resources, and wherein the communicating the first communication comprises transmitting, based on the SFI, a SL communication using the UL resources and the additional UL resources.

Aspect 11. The method of any of aspects 1-9, wherein the first time domain configuration indicates one or more uplink (UL) resources and one or more flexible resources, wherein the method further comprises: receiving a slot format indicator (SFI) indicating that at least a portion of the one or more flexible resources comprises additional UL resources, and wherein the communicating the first communication comprises monitoring, based on the SFI, for a SL communication using the UL resources and the additional UL resources.

Aspect 12. The method of any of aspects 1-9, wherein the first time domain configuration indicates one or more downlink (DL) resources and one or more flexible resources, wherein the method further comprises: receiving a slot format indicator (SFI) indicating that at least a portion of the one or more flexible resources comprise additional DL resources, and wherein the communicating the first communication comprises receiving, based on the SFI, a SL communication using the DL resources and the additional DL resources.

Aspect 13. The method of any of aspects 1-12, wherein the first time domain configuration indicates a plurality of downlink (DL) slots, and wherein the method further comprises: transmitting a listen-before-talk (LBT) success report; and receiving, based on the LBT success report, a resource split configuration indicating that a portion of the plurality of DL slots are allocated for either a SL transmission or a DL reception, and wherein the communicating the first communication is further based on the resource split configuration.

Aspect 14. The method of aspect 13, wherein the LBT success report indicates at least one of a LBT success rate or a transmission rate.

Aspect 15. The method of any of aspects 1-14, wherein the intra-band priority configuration indicates a first intra-band priority for a first traffic priority of the first communication and a second intra-band priority for a second traffic priority of the second communication.

16. The method of aspect 15, wherein the intra-band priority configuration includes an ultra-reliable low latency communications (URLLC) priority threshold.

Aspect 17. The method of aspect 16, wherein the communicating the first communication is further based on a comparison of the first traffic priority and the URLLC priority threshold.

Aspect 18. The method of any of aspects 15-17, wherein the intra-band priority configuration comprises an ultra-reliable low latency communications (URLLC) priority threshold, and wherein the intra-band priority configuration indicates that DL URLLC communications have a higher intra-band priority than SL communications.

Aspect 19. The method of any of aspects 15-18, wherein the intra-band priority configuration includes a SL priority threshold, and wherein the communicating the first communication is further based on a comparison of the first traffic priority and the SL priority threshold.

Aspect 20. The method of any of aspects 1-19, wherein the communicating the first communication comprises: refraining, based on the first time domain configuration, the second time domain configuration, and the intra-band priority configuration, from communicating the second communication during the first time period.

Aspect 21. A UE comprising a processor and a transceiver, wherein the UE is configured to perform the steps of any of aspects 1-20.

Aspect 22. A non-transitory, computer-readable having program code recorded thereon. Wherein the program code comprises instructions executable by a processor of a UE to cause the UE to perform the steps of any of aspects 1-20.

Aspect 23. A UE comprising means for performing the steps of any of aspects 1-20.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication performed at a user equipment (UE), the method comprising:
receiving a first time domain configuration for a Uu component carrier (CC);
receiving a second time domain configuration for a sidelink (SL) resource pool, wherein the Uu CC and the SL resource pool are within a same frequency band; and
communicating, based on the first time domain configuration, the second time domain configuration, and an intra-band priority configuration, a first communication at a first time period, wherein a second communication is scheduled for at least a portion of the first time period, wherein one of the first communication or the second communication comprises an SL communication in a first link direction, and wherein the other of the first communication or the second communication comprises a Uu communication for a second link direction opposite the first link direction.

2. The method of claim 1, further comprising:
receiving downlink control information (DCI) indicating a grant of SL resources,
wherein the first communication comprises a SL communication and the second communication comprises a Uu communication, and
wherein the communicating the first communication comprises communicating the SL communication on the SL resource pool based on the grant of SL resources.

3. The method of claim 2, wherein the intra-band priority configuration indicates that the SL communication has a higher priority than all Uu communications.

4. The method of claim 3, wherein the grant of SL resources comprises a dynamic grant for a SL transmission in the SL resources.

5. The method of claim 3, wherein the grant of SL resources comprises a reverse-link grant for a SL reception in the SL resources.

6. The method of claim 2, wherein the intra-band priority configuration indicates that that an intra-band priority of the second communication is based on whether the second communication is a dynamically granted Uu communication.

7. The method of claim 6, wherein the grant of SL resources comprises a dynamic grant for a SL transmission in the SL resources.

8. The method of claim 6, wherein the grant of SL resources comprises a reverse-link grant for a SL reception in the SL resources.

9. The method of claim 1, wherein the first time domain configuration indicates a set of flexible resources configurable for SL transmission or downlink (DL) reception, and wherein the method further comprises:
receiving, from a network entity, downlink control information (DCI) validating the set of flexible resources for either SL transmission or DL reception.

10. The method of claim 1, wherein the first time domain configuration indicates one or more uplink (UL) resources and one or more flexible resources,
wherein the method further comprises:
receiving a slot format indicator (SFI) indicating that at least a portion of the one or more flexible resources comprises additional UL resources, and
wherein the communicating the first communication comprises transmitting, based on the SFI, a SL communication using the one or more UL resources and the additional UL resources.

11. The method of claim 1, wherein the first time domain configuration indicates one or more uplink (UL) resources and one or more flexible resources,
wherein the method further comprises:
receiving a slot format indicator (SFI) indicating that at least a portion of the one or more flexible resources comprises additional UL resources, and
wherein the communicating the first communication comprises monitoring, based on the SFI, for a SL communication using the one or more UL resources and the additional UL resources.

12. The method of claim 1, wherein the first time domain configuration indicates one or more downlink (DL) resources and one or more flexible resources,
wherein the method further comprises:
receiving a slot format indicator (SFI) indicating that at least a portion of the one or more flexible resources comprise additional DL resources, and
wherein the communicating the first communication comprises receiving, based on the SFI, a SL communication using the one or more DL resources and the additional DL resources.

13. The method of claim 1, wherein the first time domain configuration indicates a plurality of downlink (DL) slots, and wherein the method further comprises:
transmitting a listen-before-talk (LBT) success report; and
receiving, based on transmitting the LBT success report, a resource split configuration indicating that a portion of the plurality of DL slots are allocated for either a SL transmission or a DL reception, and
wherein the communicating the first communication is further based on the resource split configuration.

14. The method of claim 13, wherein the LBT success report indicates at least one of a LBT success rate or a transmission rate.

15. The method of claim 1, wherein the intra-band priority configuration indicates a first intra-band priority for a first traffic priority of the first communication and a second intra-band priority for a second traffic priority of the second communication.

16. The method of claim 15, wherein the intra-band priority configuration comprises an ultra-reliable low latency communications (URLLC) priority threshold.

17. The method of claim 16, wherein the communicating the first communication is further based on a comparison of the first traffic priority and the URLLC priority threshold.

18. The method of claim 15, wherein the intra-band priority configuration comprises an ultra-reliable low latency communications (URLLC) priority threshold, and wherein the intra-band priority configuration indicates that DL URLLC communications have a higher intra-band priority than SL communications.

19. The method of claim 15, wherein the intra-band priority configuration comprises a SL priority threshold, and wherein the communicating the first communication is further based on a comparison of the first traffic priority and the SL priority threshold.

20. The method of claim 1, wherein the communicating the first communication comprises:
refraining, based on the first time domain configuration, the second time domain configuration, and the intra-band priority configuration, from communicating the second communication during the first time period.

21. A user equipment (UE), comprising:
a processor; and
a transceiver, wherein the UE is configured to:
receive a first time domain configuration for a Uu component carrier (CC);
receive a second time domain configuration for a sidelink (SL) resource pool, wherein the Uu CC and the SL resource pool are within a same frequency band; and
communicate, based on the first time domain configuration, the second time domain configuration, and an intra-band priority configuration, a first communication at a first time period, wherein a second communication is scheduled for at least a portion of the first time period, wherein one of the first communication or the second communication comprises an SL communication in a first link direction, and wherein the other of the first communication or the second communication comprises a Uu communication for a second link direction opposite the first link direction.

22. The UE of claim 21, wherein the UE is further configured to:
receive downlink control information (DCI) indicating a grant of SL resources,
wherein the first communication comprises a SL communication and the second communication comprises a Uu communication, and
wherein the UE is configured to communicate the SL communication on the SL resource pool based on the grant of SL resources.

23. The UE of claim 21, wherein the first time domain configuration indicates a set of flexible resources configurable for SL transmission or downlink (DL) reception, and wherein the UE is further configured to:
receive, from a network entity, downlink control information (DCI) validating the set of flexible resources for either SL transmission or DL reception.

24. The UE of claim 21, wherein the first time domain configuration indicates one or more uplink (UL) resources and one or more flexible resources,
wherein the UE is further configured to:
receive a slot format indicator (SFI) indicating that at least a portion of the one or more flexible resources comprises additional UL resources, and
wherein the UE configured to communicate the first communication comprises the UE configured to communicate, based on the SFI, a SL communication using the UL resources and the additional UL resources.

25. The UE of claim 21, wherein the first time domain configuration indicates one or more downlink (DL) resources and one or more flexible resources,
wherein the UE is further configured to:
receive a slot format indicator (SFI) indicating that at least a portion of the one or more flexible resources comprise additional DL resources, and
wherein the UE configured to communicate the first communication comprises the UE configured to communicate, based on the SFI, a SL communication using the one or more DL resources and the additional DL resources.

26. The UE of claim 21, wherein the first time domain configuration indicates a plurality of downlink (DL) slots, and wherein the UE is further configured to:
transmit a listen-before-talk (LBT) success report; and
receive, based on the LBT success report, a resource split configuration indicating that a portion of the plurality of DL slots are allocated for either a SL transmission or a DL reception, and
wherein the UE is configured to communicate the first communication further based on the resource split configuration.

27. The UE of claim 21, wherein the intra-band priority configuration indicates a first intra-band priority for a first traffic priority of the first communication and a second intra-band priority for a second traffic priority of the second communication.

28. The UE of claim 27, wherein the intra-band priority configuration comprises an ultra-reliable low latency communications (URLLC) priority threshold.

29. A non-transitory, computer-readable medium having program code recorded thereon, wherein the program code comprises instructions executable by a processor of a user equipment (UE) to cause the UE to:
receive a first time domain configuration for a Uu component carrier (CC);
receive a second time domain configuration for a sidelink (SL) resource pool, wherein the Uu CC and the SL resource pool are within a same frequency band; and
communicate, based on the first time domain configuration, the second time domain configuration, and an intra-band priority configuration, a first communication at a first time period, wherein a second communication is scheduled for at least a portion of the first time period, wherein one of the first communication or the second communication comprises an SL communication in a first link direction, and wherein the other of the first communication or the second communication comprises a Uu communication for a second link direction opposite the first link direction.

30. A user equipment (UE), comprising:
means for receiving a first time domain configuration for a Uu component carrier (CC);
means for receiving a second time domain configuration for a sidelink (SL) resource pool, wherein the Uu CC and the SL resource pool are within a same frequency band; and
means for communicating, based on the first time domain configuration, the second time domain configuration, and an intra-band priority configuration, a first communication at a first time period, wherein a second communication is scheduled for at least a portion of the first time period, wherein one of the first communication or the second communication comprises an SL communication in a first link direction, and wherein the other of the first communication or the second communication comprises a Uu communication for a second link direction opposite the first link direction.
